(19) United States
(12) Patent Application Publication
(10) Pub. No.: US 2020/0089381 A1
(43) Pub. Date: Mar. 19, 2020

(54) ALARM CLOCK REMINDER METHOD AND TERMINAL DEVICE

(71) Applicant: HUAWEI TECHNOLOGIES CO., LTD., Shenzhen (CN)

(72) Inventor: Zhenfang JI, Nanjing (CN)

(73) Assignee: HUAWEI TECHNOLOGIES CO., LTD., Shenzhen (CN)

(21) Appl. No.: 16/495,266

(22) PCT Filed: Aug. 8, 2017
(86) PCT No.: PCT/CN2017/096467

§ 371 Date: Sep. 18, 2019

(30) Foreign Application Priority Data
Mar. 21, 2017 (CN) 201710170747.5

(51) Int. Cl. G06F 3/0487; G04B 23/02; H04M 19/04; H04M 1/725

(52) U.S. Cl. CPC G06F 3/0487; H04M 1/72566; H04M 19/04; G04B 23/021

(57) ABSTRACT

Embodiments of this application provide a communication signal detection method. The method is implemented on a terminal device. The terminal device detects a trigger event; performs self-detection on the terminal based on the trigger event, where the self-detection is detecting a status of a wireless signal of the terminal device; and prompts reminder information when determining, based on the self-detection, that the wireless signal is abnormal. In technical solutions provided in the embodiments of this application, a self-detection capability and self-detection efficiency of the terminal device are improved, and a user operation is reduced, thereby improving user experience.

### CROSS-REFERENCE TO RELATED APPLICATIONS

This application is a National Stage of International Application No. PCT/CN2017/096467, filed on Aug. 8, 2017, which claims priority to Chinese Patent Application No. 201710170747.5, filed on Mar. 21, 2017. Both of the aforementioned applications are hereby incorporated by reference in their entireties.

### TECHNICAL FIELD

Embodiments of this application relate to the field of terminal technologies, and in particular, to an alarm clock reminder method and an electronic device.

### BACKGROUND

Mobile phones have penetrated into every aspect of people's lives. As smartphones become increasingly popular, the smartphones affect people's lives in an increasingly wider range. An alarm clock App is one of the most frequently used applications in applications Apps of the smartphone. As morning hours are the best time of the day to work, users often start each day with the alarm clock App.

An ordinary office worker needs to go to a company to punch in regularly every day, and usually travels by car, by public transportation, by bike, or the like. As urban traffic is increasingly congested, office workers who travel to work by car are often late for work because of external factors such as a road congestion condition and weather. Currently, an alarm clock time set by using an alarm clock App is static, and cannot be automatically and dynamically adjusted based on a real-time scenario of a user. Factors herein include but are not limited to factors such as a meeting email of the user, a work calendar of the user, a traffic road congestion condition on the way to work, and regional weather. Currently, with development of Internet technologies, many basic service vendors open their services for other third-party Apps for direct use. For example, Google and AutoNavi open a map road condition service, and AccuWeather opens a weather service. In addition, related message push mechanisms are provided for these services, and scenario information can be pushed to a mobile phone end. However, a user requirement still cannot be met by using this service.

### SUMMARY

To resolve the foregoing and/or other technical problems, embodiments of this application provide a plurality of alarm clock reminder methods and an electronic device, to greatly improve alarm flexibility and intelligence of the electronic device, simplify operation steps of a user, and improve user experience.

According to a first aspect, an embodiment of this application provides an alarm clock reminder method. The method is implemented on an electronic device, and the method includes: receiving, by the electronic device, input of an alarm clock setting, where the alarm clock setting includes a first time and application message subscription information; and setting the first time to an alarm time based on the alarm clock setting, where the application message subscription information includes a subscribed application; monitoring, by the electronic device, a notification message of the subscribed application based on the subscribed application; and obtaining, by the electronic device, an alarm clock adjustment value based on the notification message, correcting the first time based on the alarm clock adjustment value to obtain a second time, and setting the second time to the alarm time. In a technical solution, the electronic device more flexibly sets and adjusts an alarm clock, and makes a prompt with an alarm in a timely manner, thereby improving intelligence of the electronic device and user experience.

In a possible implementation, the notification message includes a notification message in a notification bar of the electronic device.

In a possible implementation, the subscribed application includes at least two applications.

In another possible implementation, the obtaining, by the electronic device, an alarm clock adjustment value based on the notification message specifically includes: obtaining, by the electronic device, event information in the notification message, determining whether an occurrence time of an event represented by the event information in the notification message falls within a time range associated with a start time of an alarm clock, and obtaining the alarm clock adjustment value based on the event information if the occurrence time of the event is earlier than the start time and if a difference obtained by subtracting the occurrence time of the event from the start time is less than a first threshold.

In another possible implementation, the obtaining, by the electronic device, an alarm clock adjustment value based on the notification message specifically includes: obtaining, by the electronic device, event information in the notification message, determining whether an occurrence time of an event represented by the event information in the notification message falls within a time range associated with a start time of an alarm clock, and obtaining the alarm clock adjustment value based on the event information if the start time is earlier than the occurrence time of the event and if a difference obtained by subtracting the start time from the occurrence time of the event is less than a second threshold.

In another possible implementation, the alarm clock setting includes a target route, the notification message includes a travel time required in the target route in a first weather condition, and the obtaining, by the electronic device, an alarm clock adjustment value based on the notification message specifically includes: determining, by the electronic device, the alarm clock adjustment value based on the travel time required in the first weather information condition.

In another possible implementation, the subscribed application includes a calendar application, and the obtaining an alarm clock adjustment value based on the notification message further specifically includes: determining the alarm clock adjustment value based on event information in notification information of the calendar application.

In another possible implementation, the electronic device analyzes the notification message by using a lexis parser.

In another possible implementation, the electronic device receives an operation of querying the alarm clock, and displays information about a subscribed application of the alarm clock.

In another possible implementation, the obtaining, by the electronic device, an alarm clock adjustment value based on the notification message further specifically includes: obtaining, by the electronic device by querying a mapping table based on the event information in the notification message, the alarm clock adjustment value corresponding to the event information.

According to a second aspect, an embodiment of this application provides an electronic device, including a display screen, a memory, one or more processors, one or more application programs, and one or more computer programs. The one or more computer programs are stored in the memory. The electronic device may be configured to perform the foregoing method.

According to a third aspect, an embodiment of this application provides an electronic device, including: a touchscreen, where the touchscreen includes a touch-sensitive surface and a display; one or more processors; a memory; a plurality of application programs; and one or more computer programs. The one or more computer programs are stored in the memory. The one or more computer programs include an instruction, and when the instruction is executed by the electronic device, the electronic device performs the foregoing method.

According to a fourth aspect, an embodiment of this application provides an electronic device. The electronic device includes a processor and a touchscreen. The touchscreen is configured to: receive input of an alarm clock setting, where the alarm clock setting includes a first time and application message subscription information; and set the first time to an alarm time based on the alarm clock setting, where the application message subscription information includes a subscribed application. The processor is configured to monitor a notification message of the subscribed application based on the subscribed application. The processor is further configured to: obtain an alarm clock adjustment value based on the notification message, correct the first time based on the alarm clock adjustment value to obtain a second time, and set the second time to the alarm time.

In a possible implementation, the processor is further configured to: obtain event information in the notification message, determine whether an occurrence time of an event represented by the event information in the notification message falls within a time range associated with a start time of an alarm clock, and obtain the alarm clock adjustment value based on the event information if the occurrence time of the event is earlier than the start time and if a difference obtained by subtracting the occurrence time of the event from the start time is less than a first threshold.

In a possible implementation, the processor is further configured to: obtain event information in the notification message, determine whether an occurrence time of an event represented by the event information in the notification message falls within a time range associated with a start time of an alarm clock, and obtain the alarm clock adjustment value based on the event information if the start time is earlier than the occurrence time of the event and if a difference obtained by subtracting the start time from the occurrence time of the event is less than a second threshold.

In another possible implementation, the electronic device further includes a display screen, and the display screen is configured to display the notification message.

In another possible implementation, the touchscreen is further configured to receive an operation of querying the alarm clock, and the display screen is further configured to display information about a subscribed application of the alarm clock.

According to a fifth aspect, an embodiment of this application further provides a computer readable storage medium. The computer readable storage medium stores an instruction. When the computer readable storage medium runs on a computer, the computer performs the method in the foregoing aspects.

According to a sixth aspect, an embodiment of this application further provides a computer program product including an instruction. When the computer program product runs on a computer, the computer performs the method in the foregoing aspects.

It should be understood that description of a technical feature, a technical solution, a beneficial effect, or similar language in this application does not imply that all features and advantages can be implemented in any single embodiment. On the contrary, it may be understood that description of a feature or a beneficial effect means that at least one embodiment includes a specific technical feature, technical solution, or beneficial effect. Therefore, in this specification, description of a technical feature, a technical solution, or a beneficial effect may not be specific to one embodiment. Further, technical features, technical solutions, or beneficial effects described in the embodiments may be combined in any proper manner. Persons skilled in the art may understand that a specific embodiment may be implemented without using one or more specific technical features, technical solutions, or beneficial effects of the embodiment. In other embodiments, additional technical features and beneficial effects may also be identified in a specific embodiment that does not reflect all the embodiments.

### BRIEF DESCRIPTION OF DRAWINGS

To describe the technical solutions in the embodiments of this application or in the prior art more dearly, the following briefly describes the accompanying drawings required for describing the embodiments or the prior art.

FIG. 1 is a schematic structural diagram of hardware of a mobile phone 100 in some embodiments;

FIG. 2A and FIG. 2B are schematic diagrams of a graphical user interface displayed on a terminal device according to some embodiments of this application;

FIG. 3 is a schematic diagram of a graphical user interface displayed on a terminal device according to some embodiments of this application;

FIG. 4 is a diagram of a graphical user interface of a notification message of a weather application according to an embodiment of this application;

FIG. 5 is a schematic diagram of a first mapping table according to an embodiment of this application;

FIG. 6 and FIG. 7 are schematic diagrams of server data of a weather application according to an embodiment of this application;

FIG. 8 is a schematic diagram of a preset mapping table according to an embodiment of this application;

FIG. 9 is a schematic diagram of adjusting a start time of an alarm clock according to an embodiment of this application;

FIG. 10 is another diagram of a graphical user interface of a notification message of a weather application according to an embodiment of this application;

FIG. 11 is another schematic diagram of adjusting a start time of an alarm clock according to an embodiment of this application;

FIG. 12 is still another diagram of a graphical user interface of a notification message of a weather application according to an embodiment of this application;

FIG. 13 is still another schematic diagram of adjusting a start time of an alarm clock according to an embodiment of this application;

FIG. 14 is a schematic diagram of setting a target route according to an embodiment of this application;

FIG. 15 and FIG. 16 are other schematic diagrams of setting a target route according to an embodiment of this application;

FIG. 17 is a diagram of a graphical user interface of a notification message of a Google map application according to an embodiment of this application;

FIG. 18 is a schematic diagram of a second mapping table according to an embodiment of this application;

FIG. 19 to FIG. 22 are schematic diagrams of server data of a traffic application according to an embodiment of this application;

FIG. 23 is another schematic diagram of adjusting a start time of an alarm clock according to an embodiment of this application;

FIG. 24 is another diagram of a graphical user interface of a notification message of a Google map application according to an embodiment of this application;

FIG. 25 is still another schematic diagram of adjusting a start time of an alarm clock according to an embodiment of this application;

FIG. 26 is a diagram of a graphical user interface of notification messages of a weather application and a Google map application according to an embodiment of this application;

FIG. 27 is a schematic diagram of a third mapping table according to an embodiment of this application;

FIG. 28 to FIG. 31 are schematic diagrams of server data of a weather application and a traffic application according to an embodiment of this application;

FIG. 32 is a schematic diagram of an alarm clock adjustment method according to an embodiment of this application;

FIG. 33 is a schematic structural diagram of an electronic device in some embodiments of this application; and

FIG. 34 is another schematic diagram of an alarm clock adjustment method according to an embodiment of this application.

### DESCRIPTION OF EMBODIMENTS

The terms used in the embodiments of this application are merely for the purpose of describing specific embodiments, but are not intended to limit this application. The terms “one,” “a,” “the,” “the foregoing,” “this,” and “the one” of singular forms used in this specification and the appended claims of this application are also intended to include plural forms, unless otherwise specified in the context clearly. It should also be understood that, the term “and/or” used in this application indicates and includes any or all possible combinations of one or more bound listed items.

In the prior art, when setting an alarm clock, a user presets a relationship between weather and a time adjustment value and a relationship between a traffic condition and a time adjustment value. After setting the alarm clock, the user adjusts an alarm clock time based on a condition on a current day. For setting of the time adjustment value for adjusting the alarm clock, refer to Table 1. Table 1 shows a correspondence between weather information and a time adjustment value, and a corresponding time adjustment value may be searched for according to a weather keyword in Table 1. For example, an alarm clock is originally set to 7:00 a.m. on a mobile phone, and if the mobile phone obtains information that a morning weather is sunny/cloudy on a current day, a time adjustment value 0 is obtained according to Table 1, and it indicates that the alarm clock time does not need to be adjusted. If morning weather is light rain on a current day, a time adjustment value 10 minutes earlier is obtained according to Table 1, and the mobile phone automatically adjusts the alarm clock to 6:50. For another case, refer to Table 1.

TABLE 1

| | | | | Heavy |
|---|---|---|---|---|
| Weather | | | Moderate | rain/ |
| keyword | Sunny/cloudy | Light rain | rain | rainstorm |
| Time | 0 | 10 minutes | 20 minutes | 30 minutes |
| adjustment | | earlier | earlier | earlier |
| value | | | | |
| Weather | Light snow | Moderate | Typhoon | . . . |
| keyword | | snow/ | | |
| | | snowstorm | | |
| Time | 20 minutes | 30 minutes | 30 minutes | . . . |
| adjustment | earlier | earlier | earlier | |
| value | | | | |

In the prior art, when setting an alarm clock, a user may alternatively set that the alarm clock is adjusted based on a traffic condition. Table 2 is a table of a correspondence between a traffic condition and a time adjustment value. For example, an alarm clock is originally set to 7:00 a.m. on a mobile phone, and if the mobile phone obtains information that a morning traffic condition is good on a current day, a time adjustment value 0 is obtained according to Table 2, and it indicates that an alarm clock time does not need to be adjusted. If a morning traffic condition is light congestion on a current day, a time adjustment value 20 minutes earlier is obtained according to Table 2, and the mobile phone automatically adjusts the alarm clock to 6:40. For another case, refer to Table 2.

TABLE 2

| | | | | |
|---|---|---|---|---|
| Traffic | Good | Light | Heavy | . . . |
| keyword | | congestion | congestion | |
| Time | 0 | 20 minutes | 30 minutes | . . . |
| adjustment | | earlier | earlier | |
| value | | | | |

In the prior art, other factors such as a temperature and preparation duration of a user that affect alarm clock adjustment may be further added for alarm clock adjustment.

A different weight may be further set for each factor, and data within a recent time period may be further automatically stored, to evaluate a new delay time, and finally calculate an alarm clock time on a current day. Precision of an alarm clock adjustment value is affected by various factors. For example, only light rain, moderate rain, heavy rain, and the like are defined in terms of weather condition, light congestion, moderate congestion, and the like are defined in terms of traffic, and a time adjustment value corresponding to each level further needs to be set by the user. Consequently, an adjustment value set by the user may be inaccurate, and accordingly the precision is affected. For example, a road is congested because of vehicle collision at 6:30, but a road obstacle is removed at 7:00. In this case, alarm clock adjustment should not be affected by a traffic condition, but a mobile phone cannot flexibly process this type of situation.

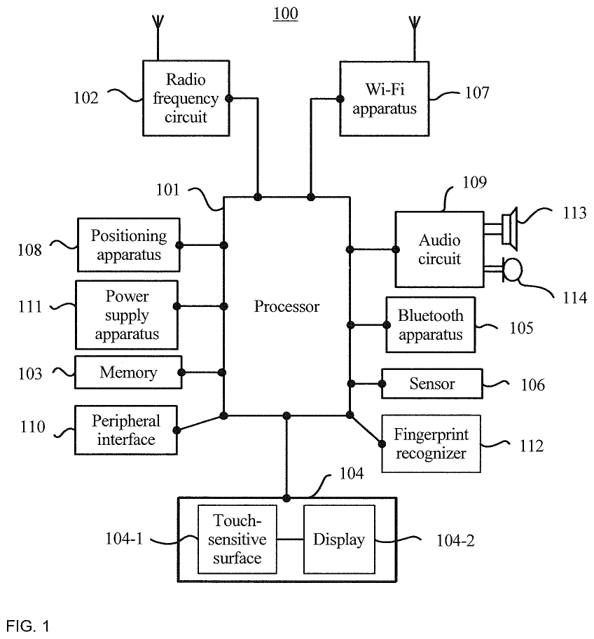

As shown in FIG. 1, an electronic device in an embodiment of this application may be a mobile phone 100. The mobile phone 100 is used as an example below to describe this embodiment in detail. It should be understood that the mobile phone 100 shown in the figure is merely an example of the electronic device, and the mobile phone 100 may have more or fewer components than those shown in the figure, may combine two or more components, or may have different component configurations. Various components shown in the figure may be implemented in hardware that includes one or more signal processors and/or application-specific integrated circuits, in software, or in a combination of hardware and software.

As shown in FIG. 1, the mobile phone 100 may specifically include components such as a processor 101, a radio frequency (radio frequency, RF) circuit 102, a memory 103, a touchscreen 104, a Bluetooth apparatus 105, one or more sensors 106, a Wi-Fi apparatus 107, a positioning apparatus 108, an audio circuit 109, a peripheral interface 110, and a power supply system 111. These components may communicate with each other by using one or more communications buses or signal lines (not shown in FIG. 1). Persons skilled in the art may understand that a hardware structure shown in FIG. 1 does not constitute a limitation on the mobile phone 100, and the mobile phone 100 may include more or fewer components than those shown in the figure, or combine some components, or have different component arrangements.

The components of the mobile phone 100 are described below in detail with reference to FIG. 1.

The processor 101 is a control center of the mobile phone 100, connects all parts of the mobile phone 100 by using various interfaces and lines, and performs various functions of the mobile phone 100 and data processing by running or executing an application program (Application, App for short) stored in the memory 103 and invoking data and an instruction that are stored in the memory 103. In some embodiments, the processor 101 may include one or more processing units. An application processor and a modem processor may be further integrated into the processor 101. The application processor mainly processes an operating system, a user interface, an application program, and the like. The modem processor mainly processes wireless communication. It may be understood that the modem processor may alternatively not be integrated into the processor 101. In some embodiments of this application, the processor 101 may further include a fingerprint verification chip, configured to verify a collected fingerprint.

The radio frequency circuit 102 may be configured to receive and send a wireless signal in an information receiving and sending process or in a call process. Specifically, after receiving downlink data from a base station, the radio frequency circuit 102 may send the downlink data to the processor 101 for processing; and in addition, send uplink data to the base station. Usually, the radio frequency circuit includes but is not limited to an antenna, at least one amplifier, a transceiver, a coupler, a low noise amplifier, a duplexer, and the like. In addition, the radio frequency circuit 102 may further communicate with another device through wireless communication. Any communications standard or protocol may be used for the wireless communication, and includes but is not limited to a Global System for Mobile Communications, a general packet radio service, Code Division Multiple Access, Wideband Code Division Multiple Access, Long Term Evolution, an email, a short message service, and the like.

The memory 103 is configured to store an application program and data. The processor 101 performs various functions of the mobile phone 100 and data processing by running the application program and the data that are stored in the memory 103. The memory 103 mainly includes a program storage area and a data storage area. The program storage area may store an operating system and an application program required by at least one function (for example, a sound playing function or an image playing function). The data storage area may store data (for example, audio data or a phone book) created based on use of the mobile phone 100. In addition, the memory 103 may include a high-speed random access memory, and may further include a nonvolatile memory, for example, a magnetic disk storage component, a flash storage component, or another volatile solid-state storage component. The memory 103 may store various operating systems, for example, an IOS® operating system developed by Apple and an Android® operating system developed by Google.

The touchscreen 104 may include a touch-sensitive surface 104-1 and a display 104-2. The touch-sensitive surface 104-1 (for example, a touch panel) may collect a touch event (for example, an operation performed by a user on the touch-sensitive surface 104-1 or near the touch-sensitive surface 104-1 by using any appropriate object such as a finger or a stylus) performed by the user of the mobile phone 100 on or near the touch-sensitive surface, and send collected touch information to another component, for example, the processor 101. The touch event performed by the user near the touch-sensitive surface 104-1 may be referred to as a floating touch. The floating touch may mean that the user does not need to directly come into contact with a touchpad to select, move, or drag a target (for example, an icon), and the user only needs to be near the electronic device to perform a wanted function. In an application scenario of the floating touch, terms such as “touch” and “contact” do not imply a direct contact with the touchscreen, but a contact near or close to the touchscreen. The touch-sensitive surface 104-1 that can perform the floating touch may be implemented in a capacitive type, an infrared light sensing type, an ultrasonic wave type, or the like. The touch-sensitive surface 104-1 may include two parts: a touch detection apparatus and a touch controller. The touch detection apparatus detects a touch position of the user, detects a signal brought by a touch operation, and transfers the signal to the touch controller. The touch controller receives touch information from the touch detection apparatus, converts the touch information into touch point coordinates, and then sends the touch point coordinates to the processor 101. The touch controller may further receive and execute an instruction sent by the processor 101. In addition, the touch-sensitive surface 104-1 may be implemented in various types such as a resistive type, a capacitive type, an infrared ray type, and a surface acoustic wave type. The display (also referred to as a display screen) 104-2 may be configured to display information entered by the user or information provided for the user, and various menus of the mobile phone 100. The display 104-2 may be configured in a form of a liquid crystal display, an organic light-emitting dioxide, or the like. The touch-sensitive surface 104-1 may cover the display 104-2. After detecting the touch event on or near the touch-sensitive surface 104-1, the touch-sensitive surface 104-1 transfers the touch event to the processor 101 to determine a type of the touch event. Then the processor 101 may provide corresponding visual output on the display 104-2 based on the type of the touch event. Although in FIG. 1, the touch-sensitive surface 104-1 and the display screen 104-2 are used as two independent components to implement input and output functions of the mobile phone 100, in some embodiments, the touch-sensitive surface 104-1 and the display screen 104-2 may be integrated to implement the input and output functions of the mobile phone 100. It may be understood that the touchscreen 104 is formed by stacking a plurality of layers of materials, only the touch-sensitive surface (layer) and the display screen (layer) are presented in this embodiment of this application, and other layers are not recorded in this embodiment of this application. In addition, in some other embodiments of this application, the touch-sensitive surface 104-1 may cover the display 104-2, and a size of the touch-sensitive surface 104-1 is greater than a size of the display screen 104-2, so that the display screen 104-2 is totally covered by the touch-sensitive surface 104-1. Alternatively, the touch-sensitive surface 104-1 may be configured in a form of a full panel on the front of the mobile phone 100, in other words, all touches of the user on the front of the mobile phone 100 can be perceived by the mobile phone. In this way, all-touch experience on the front of the mobile phone can be implemented. In some other embodiments, the touch-sensitive surface 104-1 is configured in a form of a full panel on the front of the mobile phone 100, and the display screen 104-2 may also be configured in a form of a full panel on the front of the mobile phone 100. In this way, a frame-less structure can be implemented on the front of the mobile phone.

In embodiments of this application, the mobile phone 100 may further have a fingerprint recognition function. For example, a fingerprint recognizer 112 may be configured on the back (for example, below a rear-facing camera) of the mobile phone 100, or a fingerprint recognizer 112 is configured on the front (for example, below the touchscreen 104) of the mobile phone 100. Alternatively, a fingerprint recognizer 112 may be configured in the touchscreen 104 to implement the fingerprint recognition function. In other words, the fingerprint recognizer 112 and the touchscreen 104 may be integrated to implement the fingerprint recognition function of the mobile phone 100. In this case, the fingerprint recognizer 112 may be configured in the touchscreen 104, and may be a part of the touchscreen 104, or may be configured in the touchscreen 104 in another manner. In addition, the fingerprint recognizer 112 may be further implemented as a full-panel fingerprint recognizer. Therefore, the touchscreen 104 may be considered as a panel in which a fingerprint can be collected at any location. The fingerprint recognizer 112 may send a collected fingerprint to the processor 101, so that the processor 101 processes the fingerprint (for example, fingerprint verification). A main component of the fingerprint recognizer 112 in this embodiment of this application is a fingerprint sensor. The fingerprint sensor may use any type of sensing technology, including but not limited to an optical type, a capacitive type, a piezoelectric type, an ultrasonic wave sensor technology, or the like.

The mobile phone 100 may further include the Bluetooth apparatus 105, configured to implement data exchange between the mobile phone 100 and another short-range electronic device (for example, a mobile phone or a smartwatch). The Bluetooth apparatus in this embodiment of this application may be an integrated circuit, a Bluetooth chip, or the like.

The mobile phone 100 may further include at least one sensor 106, for example, a light sensor, a motion sensor, and other sensors. Specifically, the light sensor may include an ambient light sensor and a proximity sensor. The ambient light sensor may adjust luminance of the display of the touchscreen 104 based on brightness of ambient light. The proximity sensor may power off the display when the mobile phone 100 moves to an ear. As a type of motion sensor, an accelerometer sensor may detect a value of acceleration in each direction (usually on three axes), may detect a value and a direction of gravity in a static state, and may be used in an application for recognizing a mobile phone posture (such as screen switching between a landscape mode and a portrait mode, a related game, or magnetometer posture calibration), a function related to vibration recognition (such as a pedometer or a knock), or the like. Other sensors such as a gyroscope, a barometer, a hygrometer, a thermometer, or an infrared sensor may be further configured in the mobile phone 100. Details are not described herein.

The Wi-Fi apparatus 107 is configured to provide the mobile phone 100 with network access that complies with a Wi-Fi related standard protocol. The mobile phone 100 may access a Wi-Fi access point by using the Wi-Fi apparatus 107, to help the user receive and send an email, browse a web page, access streaming media, and the like. The Wi-Fi apparatus provides wireless broadband Internet access for the user. In some other embodiments, the Wi-Fi apparatus 107 may be used as a Wi-Fi wireless access point, and may provide Wi-Fi network access for another electronic device.

The positioning apparatus 108 is configured to provide a geographical position for the mobile phone 100. It may be understood that the positioning apparatus 108 may be specifically a receiver of a positioning system such as a Global Positioning System (global positioning system, GPS) or the BeiDou Navigation Satellite System. After receiving a geographical position sent by the positioning system, the positioning apparatus 108 sends the information to the processor 101 for processing, or sends the information to the memory 103 for storage. In some other embodiments, the positioning apparatus 108 may be a receiver of an Assisted Global Positioning System (assisted global positioning system, AGPS). The AGPS runs in a manner in which GPS positioning is performed with specific assistance. By using a signal of a base station together with a GPS satellite signal, the AGPS can enable a positioning speed of the mobile phone 100 to be higher. In the AGPS system, the positioning apparatus 108 may obtain positioning assistance through communication with an assisted positioning server (for example, a mobile phone positioning server). As an assisted server, the AGPS system assists the positioning apparatus 108 in completing ranging and positioning services. In this case, the assisted positioning server provides positioning assistance through communication with the positioning apparatus 108 (namely, a receiver of the GPS) of the electronic device such as the mobile phone 100 by using a wireless communications network. In some other embodiments, the positioning apparatus 108 may be a positioning technology that is based on a Wi-Fi access point. Each Wi-Fi access point has a globally unique MAC address, and the electronic device can scan and collect a broadcast signal of a surrounding Wi-Fi access point when Wi-Fi is enabled. Therefore, the electronic device can obtain a MAC address broadcast by the Wi-Fi access point. The electronic device sends data (for example, the MAC address) that can identify the Wi-Fi access point to a position server by using the wireless communications network. The position server retrieves a geographical position of each Wi-Fi access point, calculates a geographical position of the electronic device with reference to strength of the Wi-Fi broadcast signal, and sends the geographical position to the positioning apparatus 108 of the electronic device.

The audio circuit 109, a loudspeaker 113, and a microphone 114 may provide an audio interface between the user and the mobile phone 100. The audio circuit 109 may convert received audio data into an electrical signal, and then transmit the electrical signal to the loudspeaker 113. The loudspeaker 113 converts the electrical signal into a sound signal for output. In addition, the microphone 114 converts a collected sound signal into an electrical signal, and the audio circuit 109 converts the electrical signal into audio data after receiving the electrical signal, and then outputs the audio data to the RF circuit 102 to send to, for example, another mobile phone, or outputs the audio data to the memory 103 for further processing.

The peripheral interface 110 is configured to provide various interfaces for an external input/output device (such as a keyboard, a mouse, an external display, an external memory, or a subscriber identity module card). For example, the peripheral interface 110 is connected to the mouse by using a universal serial bus interface, and is connected, by using a metal touch point on a subscriber identity module card slot, to a subscriber identity module (subscriber identity module, SIM) card provided by a telecommunications operator. The peripheral interface 110 may be configured to couple the external input/output peripheral device to the processor 101 and the memory 103.

The mobile phone 100 may further include the power supply apparatus 111 (such as a battery and a power management chip) that supplies power to each component. The battery may be logically connected to the processor 101 by using the power management chip, to implement functions such as charging management, discharging management, and power consumption management by using the power supply apparatus 111.

Although not shown in FIG. 1, the mobile phone 100 may further include a camera (a front-facing camera and/or a rear-facing camera), a flash, a micro projection apparatus, a near field communication (near field communication, NFC) apparatus, and the like. Details are not described herein.

All the following embodiments may be implemented in an electronic device (such as the mobile phone 100) that has the foregoing hardware. The embodiments of this application are described below with reference to FIG. 1.

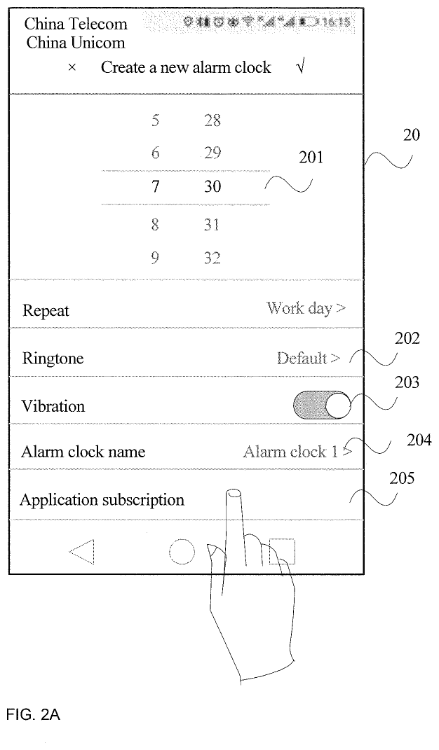

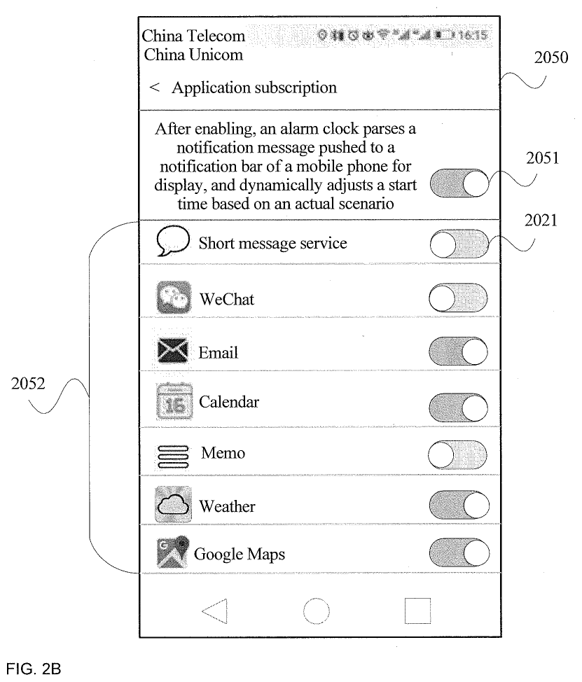

FIG. 2A is a schematic diagram of a graphical user interface displayed on a terminal device according to some embodiments of this application. A new-alarm-clock creation function of an alarm clock app is enabled on a mobile phone 100, so that the schematic diagram of the graphical user interface shown in FIG. 2A can be displayed. In FIG. 2A, a preset time of a newly created alarm clock and a newly added application subscription mode are shown. FIG. 2A is a schematic diagram of an example of the newly created alarm clock. As shown in FIG. 2A, a new-alarm-clock creation interface 20 may include a plurality of attribute setting controls, for example, a time setting control 201, a ringtone setting control 202, a vibration mode setting control 203, and an alarm clock name setting control 204. The plurality of attribute setting controls may be used by a user to select one or more attributes of the alarm clock, for example, a start time, a ringtone, a vibration mode, and an alarm clock name. In some embodiments of this application, the new-alarm-clock creation interface 10 may further include an application subscription control 205. The application subscription control 105 may be configured to receive an operation that is of opening an application subscription interface and that is entered by the user. When detecting the opening operation (for example, a tap operation) by using the application subscription control 205, a system displays an application subscription interface 2050 shown in FIG. 2B.

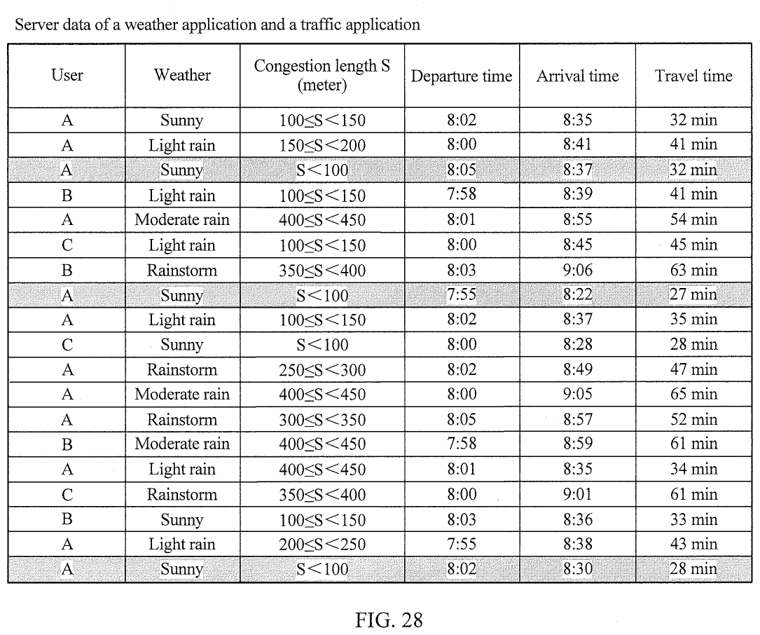

If the mobile phone 100 receives a tap from the user on the application subscription control 205 to select an application subscription mode, the mobile phone 100 enters a schematic diagram of a graphical user interface shown in FIG. 2B. FIG. 2B is a schematic diagram of an example of the application subscription interface. As shown in FIG. 28, the application subscription interface 2050 may include a mode on/off control 2051 and an application list 2052. The mode on/off control 2051 is configured to receive an operation that is of enabling or disabling a subscription mode and that is entered by the user. Specifically, when the subscription mode is enabled, an operation entered by the user on the application list 2052 is valid. When the subscription mode is disabled, an operation entered by the user on the application list 2052 is invalid. Optionally, the mode on/off control 2051 may be implemented as a sliding on/off control shown in FIG. 2B. Specifically, when a button on the sliding on/off control is slid to the right, it indicates that the subscription mode is enabled; and when the button on the sliding on/off control is slid to the left, it indicates that the subscription mode is disabled. A manner in which the user enables or disables the subscription mode by operating the sliding on/off control is not limited herein. In addition, the mode on/off control 2051 is not limited to being implemented as the sliding on/off control shown in FIG. 2B, and may use another control during actual application. The application list 2052 is used to present a plurality of applications. The user may select, based on a requirement from the plurality of applications presented in the application list 2052, an application to which the user needs to subscribe. FIG. 2B shows an example in which the user subscribes to applications such as an email application, a calendar application, a weather application, and a Google map application for an alarm clock 1. Herein, subscription may mean that the user sets some specific applications whose notification messages affect a start time of the alarm clock. For example, it is assumed that the user subscribes to the “weather” application, and it indicates that a notification message of the “weather” application may affect the start time of the alarm clock.

Specifically, a subscription operation entered by the user may be received by using an on/off control 2021 shown in FIG. 2B. Specifically, when a button on an on/off control 2021 corresponding to each application Is slid to the right, it indicates that the application is subscribed to. In addition, the on/off control is not limited to being implemented as the on/off control shown in FIG. 2B, and may use another control during actual application. A manner in which the user enters the subscription operation by operating the on/off control is not limited.

As shown in FIG. 2B, the application subscription interface is entered, and the user may choose to enable the function. When the application subscription function is enabled, in the application subscription mode, the alarm clock application dynamically adjusts a preset alarm clock with reference to an actual scenario and based on a notification message that is received by the mobile phone 100 and that is pushed to a status bar of the mobile phone for display. As shown in FIG. 2B, the application subscription interface displays a list of applications that can be subscribed to, and the user may select a corresponding application based on a requirement. The list of applications that can be subscribed to may include but be not limited to the following applications: a short message service application, a calendar application, a WeChat application, an Amap application, a weather application, a memo application, an email application, and the like. FIG. 2B is used as an example. The user may enter a selection operation to choose to subscribe to notification messages of the calendar application, the Amap application, the weather application, and the email application. The user may choose to subscribe to an application by turning on a selection button or checking a check box. This is not specifically limited in this embodiment of this application. The alarm clock application on the mobile phone 100 dynamically adjusts the preset alarm clock based on the notification messages of the calendar application, the Amap application, the weather application, and the email application on the mobile phone 100. After setting is completed, the mobile phone 100 may store an alarm clock time set in the alarm clock application and information about the subscribed application into a memory 103 of the mobile phone 100.

In some embodiments of this application, the mobile phone 100 receives, by using a touch-sensitive surface 104-1, an operation of enabling the alarm clock application by the user. The processor 101 runs the alarm clock application, and displays, by using a display 104-2, the graphical user interface shown in FIG. 2A. The mobile phone 100 receives, by using the touch-sensitive surface 104-1, an operation of tapping, by the user, to choose to enter the application subscription mode of the alarm clock application. The alarm clock application loads the list of applications that can be subscribed to, and displays, by using the display 104-2, the graphical user interface shown in FIG. 2B, to display the list of applications that can be subscribed to. The mobile phone 100 receives, by using the touch-sensitive surface 104-1, an operation performed by the user on the list of applications that can be subscribed to and an operation of enabling the application subscription mode. After setting is completed, the alarm clock application automatically monitors notification bar messages of an email application, a weather application, a map application, and a calendar application. Once it is detected, through listening, that a notification message is pushed to the mobile phone 100, the alarm clock application performs semantic analysis on the notification bar message to obtain a factor that affects an alarm clock adjustment value, and then automatically adjusts an alarm time of an alarm clock based on the alarm clock adjustment value. For a manner in which the alarm clock application specifically adjusts an original preset alarm clock time, for example, for setting of a correspondence between different alarm clock adjustment values and different trigger events in different applications, refer to setting manners in Table 1 and Table 2. The alarm time set by the alarm clock application, a list of subscribed applications whose notification bar messages are subscribed to, and the like may be stored in a memory 103 for subsequent processing and calculation. In some embodiments of this application, the user may select, by using an alarm clock time set by using the touch-sensitive surface 104-1, a subscribed application whose notification bar message is subscribed to. The memory 103 stores the information, so that the information is used by the processor 101 to perform logical calculation.

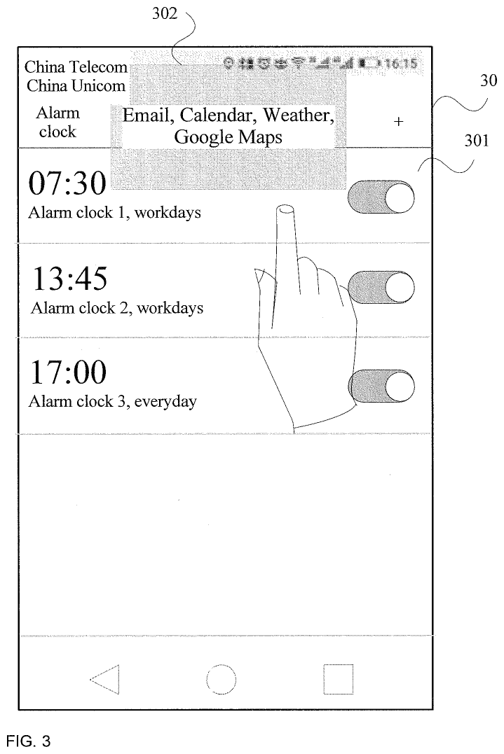

FIG. 3 shows an example of an application associated with an alarm clock. As shown in FIG. 3, a start time of the alarm clock 1 is set to 7:30, and associated applications include an email application, a calendar application, a weather application, and a Google map application. The user may set, by using the graphical user interfaces shown in FIG. 2A and FIG. 2B, these applications associated with the alarm clock 1, in other words, set these applications to applications associated with the alarm clock 1. Optionally, as shown in FIG. 3, the user may view, by performing an operation such as a tap operation or a touch and hold operation, the applications associated with the alarm clock 1. When the user taps or touches and holds a control interface 301 corresponding to the alarm clock 1 in an interface 30, the user may view, in a floating window 302, the applications set by the user to be associated with the alarm clock 1. A viewing manner is not limited to a manner of viewing, by performing the operation such as the tap operation or the touch and hold operation, the applications associated with the alarm clock 1, and a displaying manner is not limited to a manner of displaying, in the floating window, the applications associated with the alarm clock 1. Similarly, an application associated with another alarm clock may be set, and the application associated with the another alarm clock may be viewed.

In some embodiments of this application, the notification message of the subscribed application may be referred to as a first message, and the application list 2052 shown in FIG. 2A may be referred to as a first application list.

In some embodiments of this application, a factor that affects the start time of the alarm clock may include at least one of the following: weather, traffic, or an event, for example, weather included in a notification message of a weather application, a short message service application, a WeChat application, or the like, and for another example, traffic included in a notification message of a traffic application.

Herein, the event may include an event included in a notification message of a short message service application, an email application, a WeChat application, a calendar application, a memo application, or the like, for example, a to-do event included in the notification message of the calendar application, the memo application, or the like, and for another example, a meeting included in the notification message of the email application.

In some embodiments of this application, an affecting factor that meets a preset condition affects the start time of the alarm clock. Specifically, whether an affecting factor included in the first message meets the preset condition may be determined in the following manners.

In a first implementation, whether weather represented by weather information included in the first message is consistent with first weather may be determined. If the weather represented by the weather information is consistent with the first weather, the weather represented by the weather information meets the preset condition. It may be understood that an application that provides the first message may be a weather application. A notification message of the weather information is not limited to the weather information provided by the weather application, and may alternatively be weather information provided by another application (for example, a short message service application) to which the user subscribes.

The first weather may be severe weather, for example, weather such as light rain, moderate rain, heavy rain, rainstorm, thundershower, sleet, light snow, or heavy snow that may cause travel inconvenience to people.

In a second implementation, whether a traffic congestion degree represented by traffic information included in the first message is greater than a traffic congestion threshold may be determined. If yes, traffic represented by the traffic information meets the preset condition. It may be understood that an application that provides the first message may be a traffic application.

In a third implementation, whether an occurrence time of an event represented by event information included in the first message falls within a time range associated with the start time of the alarm clock may be determined. If the occurrence time of the event is earlier than the start time, and a difference obtained by subtracting the occurrence time of the event from the start time is less than a first threshold, in other words, if the occurrence time of the event is earlier than the start time of the alarm clock, and is close to the start time of the alarm clock, the start time needs to be adjusted, so that the user makes preparations for the event in advance. In this case, the event information represented by the first message meets the preset condition. If the start time is earlier than the occurrence time of the event, and a difference obtained by subtracting the start time from the occurrence time of the event is less than a second threshold, in other words, if the occurrence time of the event is later than the start time of the alarm clock, and is close to the start time of the alarm clock, the start time may need to be adjusted, so that the user makes preparations for the event in advance. In this case, the preset condition is met. It may be understood that an application that provides the first message may be a short message service application, an email application, a calendar application, a memo application, or the like.

In a fourth implementation, when the first message includes at least two of weather, traffic, and an event, whether a combination of the at least two factors included in the first message belongs to a first set may be determined. The preset condition is met if the combination of the at least two factors belongs to the first set. The first set includes a plurality of combinations of the at least two factors. Weather in each combination is consistent with first weather, a traffic congestion degree in each combination is greater than a traffic congestion threshold, and an occurrence time of an event in each combination falls within a time range associated with the start time of the alarm clock.

A terminal may adjust the start time of the alarm clock provided that it is determined that the affecting factor included in the first message meets the preset condition.

The following separately describes, by using a plurality of embodiments, how to adjust the start time of the alarm clock based on the affecting factor included in the first message.

In some embodiments of this application, a notification message provided by a weather application is used as an example to describe how to adjust the start time of the alarm clock based on the notification message of the application. The notification message is the first message.

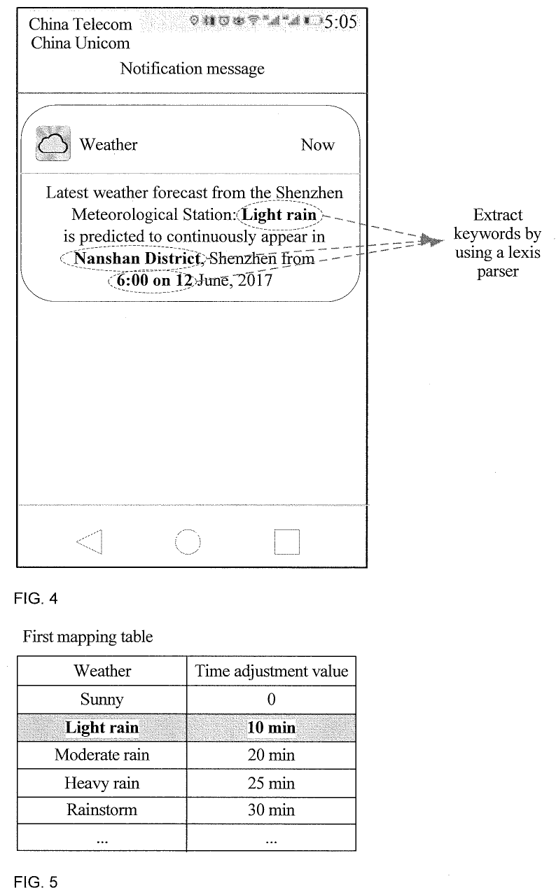

FIG. 4 shows an example of a notification message of a weather application. As shown in FIG. 4, keywords such as “6:00 on 12”, “Nanshan District”, and “light rain” may be extracted by using a lexis parser. It is assumed that first weather is non-sunny. In this case, an affecting factor represented by the extracted information shown in FIG. 4 meets the preset condition, in other words, the start time of the alarm clock needs to be adjusted based on the first message.

FIG. 5 shows an example of a first mapping table. As shown in FIG. 5, a time adjustment value corresponding to weather represented by weather information included in the first message may be determined by using the first mapping table. The time adjustment value represents a degree to which the weather represented by the weather information affects the start time of the alarm clock. The alarm clock application may adjust the start time of the alarm clock based on the time adjustment value. Specifically, after a keyword is extracted, the weather represented by the weather information is determined, and the time adjustment value corresponding to the weather is searched for according to the first mapping table. For example, weather represented by the notification message in FIG. 4 is light rain, and it may be found, according to the first mapping table in FIG. 5, that a time adjustment value corresponding to light rain is 10 min.

Further, a time adjustment value of the start time may be specifically related to travel times in which the user travels in a route in different weather. Herein, the travel route may be referred to as a target route.

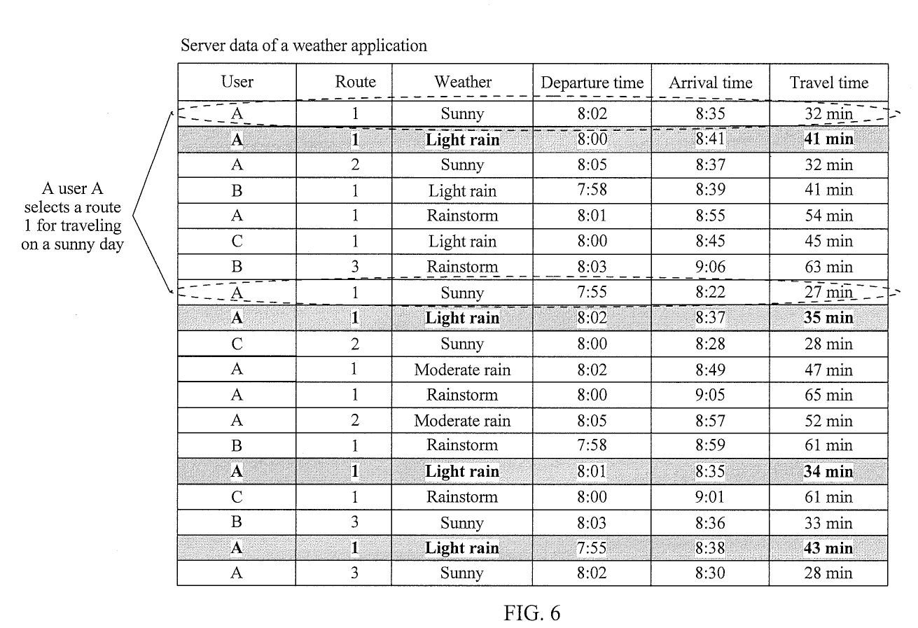

FIG. 6 shows an example of server data of a weather application. As shown in FIG. 6, the server data of the weather application may include travel times in which different users travel in different routes in different weather. In some embodiments of this application, travel times in which a specific user travels in a target route in different weather may be obtained through matching by using the server data of the weather application. In some embodiments of this application, alternatively, travel times in which a specific user travels in a target route in different weather may be obtained through matching by using server data of a map application. This is not limited in this embodiment of this application.

It is assumed that the user is a user A in FIG. 6, the alarm clock is the alarm clock 1 (the start time is 7:30) shown in FIG. 1, a notification message pushed by the weather application is the notification message shown in FIG. 4, and the target route is a route 1. Specifically, the time adjustment value of the start time may be determined based on the server data of the weather application in the following manners.

In a first implementation, it is assumed that the start time 7:30 is set by the user based on a travel time of traveling in the route 1 on a sunny day. In different weather, the time adjustment value of the start time may be a difference between a travel time of traveling in the route 1 in each weather and the travel time of traveling in the route 1 on a sunny day. The travel time in which the user travels in the target route in each weather may be an average value of a plurality of travel times.

Optionally, the time adjustment value of the start time may be determined based on historical data of the user. In this case, the time adjustment value is determined in the following several steps.

First, an average value of travel times required when the user A selects the route 1 on a sunny day is calculated. In data shown in FIG. 6, the travel times on a sunny day are respectively 32 min and 27 min, and therefore the obtained average value is 30 min. Therefore, a travel time required when the user A selects the route 1 on a sunny day is 30 min.

Then, an average value of travel times required when the user A selects the route 1 on a light rain day is calculated. As shown in data in gray parts in FIG. 6, the travel times on a light rain day are respectively 41 min, 35 min, 34 min, and 43 min, and therefore the obtained average value is 38 min. Therefore, a travel time required when the user A selects the route 1 on a light rain day is 38 min.

Finally, the time adjustment value of the start time of the alarm clock on a light rain day is determined based on the travel time required when the user A selects the route 1 on a sunny day and the travel time required when the user A selects the route 1 on a light rain day. A time adjustment value corresponding to light rain is a difference between the travel time required when the user A selects the route 1 on a sunny day and the travel time required on a light rain day, that is, 38−30=8 min.

Optionally, the time adjustment value of the start time may be determined based on historical data of all users. In this case, the time adjustment value is determined in the following several steps.

First, an average value of travel times required when all the users select the route 1 on a sunny day is calculated. In data shown in FIG. 6, the travel times on a sunny day are respectively 32 min and 27 min, and therefore the obtained average value is 30 min. Therefore, a travel time required when all the users select the route 1 on a sunny day is 30 min.

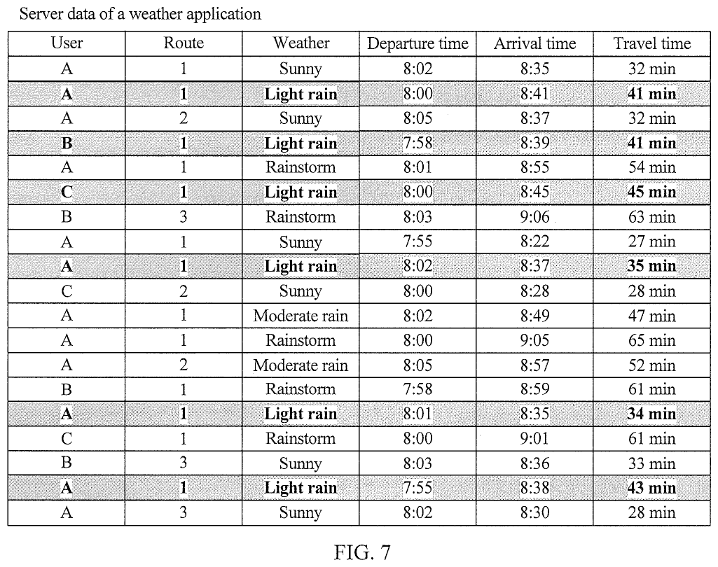

Then, an average value of travel times required when all the users select the route 1 on a light rain day is calculated. As shown in data in gray parts in FIG. 7, the travel times on a light rain day are respectively 41 min, 41 min, 45 min, 35 min, 34 min, and 43 min, and therefore the obtained average value is 40 min. Therefore, a travel time required when all the users select the route 1 on a light rain day is 40 min.

Finally, the time adjustment value of the start time of the alarm clock on a light rain day is determined based on the travel time required when all the users select the route 1 on a sunny day and the travel time required when al the users select the route 1 on a light rain day. A time adjustment value corresponding to light rain is a difference between the travel time required when all the users select the route 1 on a sunny day and the travel time required on a light rain day, that is, 40−30=10 min.

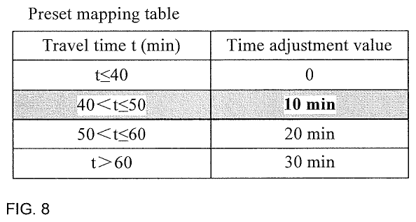

In a second implementation, different ranges of travel times of traveling in the target route and time adjustment values corresponding to the different ranges are preset. FIG. 8 shows an example of a preset mapping table. The preset mapping table includes time adjustment values corresponding to different travel time ranges. As shown in FIG. 8, four ranges of travel times t may be set: t≤40 min, 40 min<t≤50 min, 50 min<t≤60 min, and t>60 min. The four ranges respectively correspond to the following time adjustment values: 0, 10 min, 20 min, and 30 min. A travel time in which the user travels in the target route in each weather may be an average value of a plurality of travel times.

Similarly, travel times of traveling in the target route in different weather may be determined based on historical data of the user or historical data of all users. In an example, the travel times of traveling in the target route in the different weather are determined based on the historical data of the user. In this case, the time adjustment value is determined in the following several steps.

First, an average value of travel times required when the user A selects the route 1 on a light rain day is calculated. As shown in data in gray parts in FIG. 6, the travel times on a light rain day are respectively 41 min, 35 min, 34 min, and 43 min, and therefore the obtained average value is 38 min. Therefore, a travel time required when the user A selects the route 1 on a light rain day is 38 min.

Then, a travel time range to which the travel time belongs in the preset mapping table is determined based on the travel time required when the user A selects the route 1 in this weather. It can be known, from the preset mapping table shown in FIG. 8, that the range to which the travel time required when the user A selects the route 1 on a light rain day belongs is 40 min<t≤50 min.

Finally, a time adjustment value corresponding to the travel time range is searched for according to the preset mapping table. It may be determined, according to the preset mapping table shown in FIG. 8, that the time adjustment value corresponding to the travel time range is 10 min, in other words, the time adjustment value required when the user A selects the route 1 on a light rain day is 10 min.

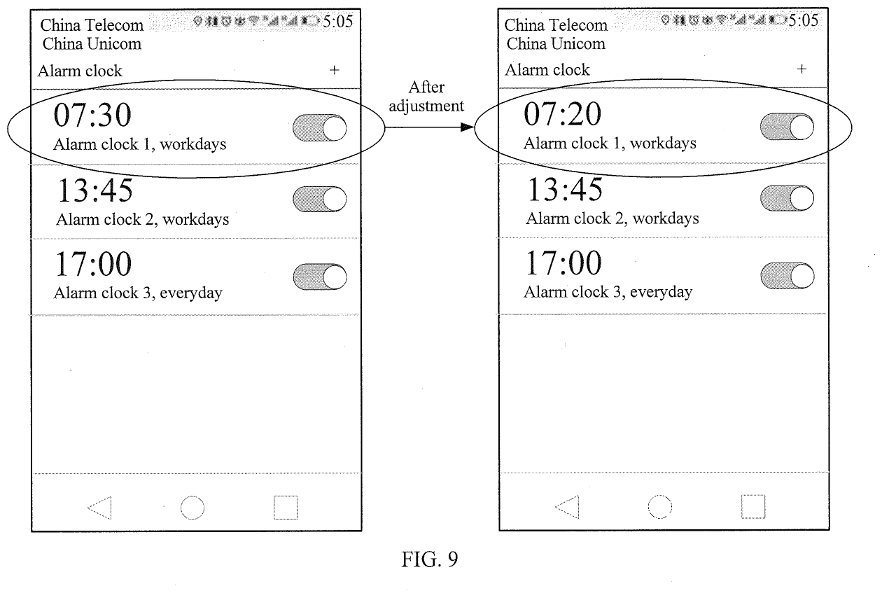

FIG. 9 shows an example of adjusting a start time of an alarm clock. As shown in FIG. 9, if it is determined, in any one of the foregoing manners, that the time adjustment value is 10 min, the start time of the alarm clock is adjusted based on the time adjustment value, in other words, the start time 7:30 of the alarm clock 1 may be adjusted to 7:20.

In some possible scenarios, the notification message pushed by the weather application may change, in other words, weather may become worse or better.

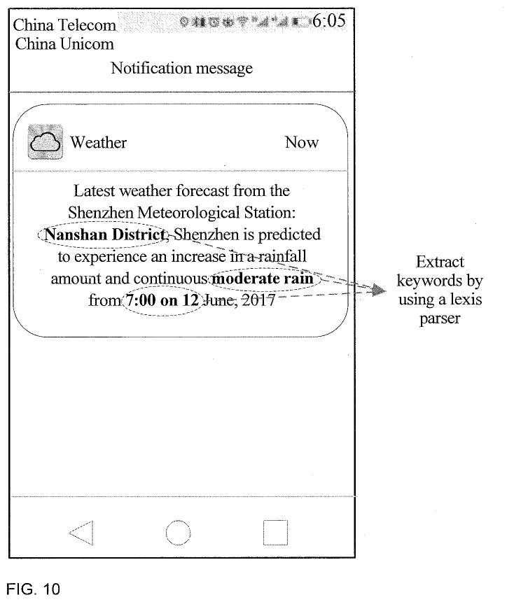

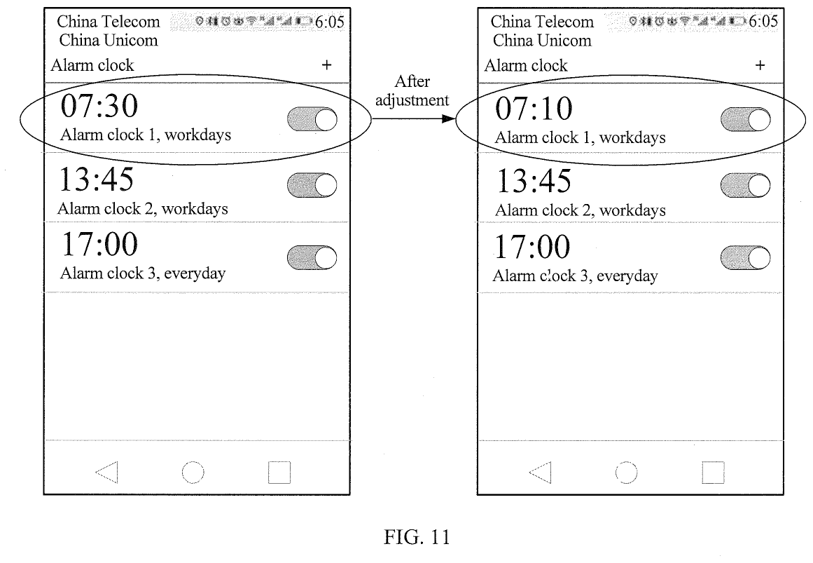

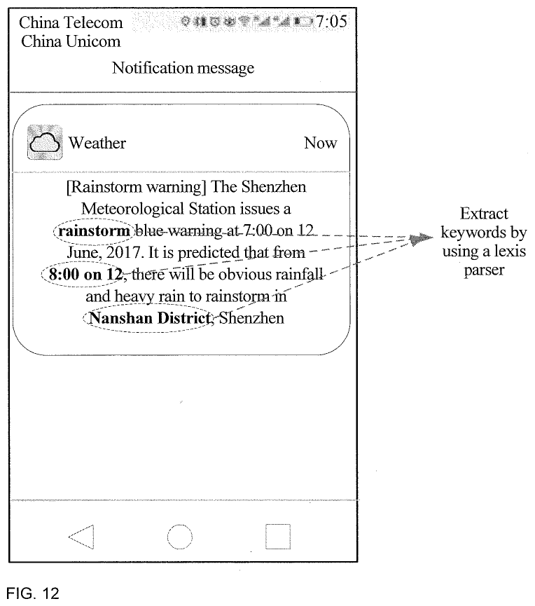

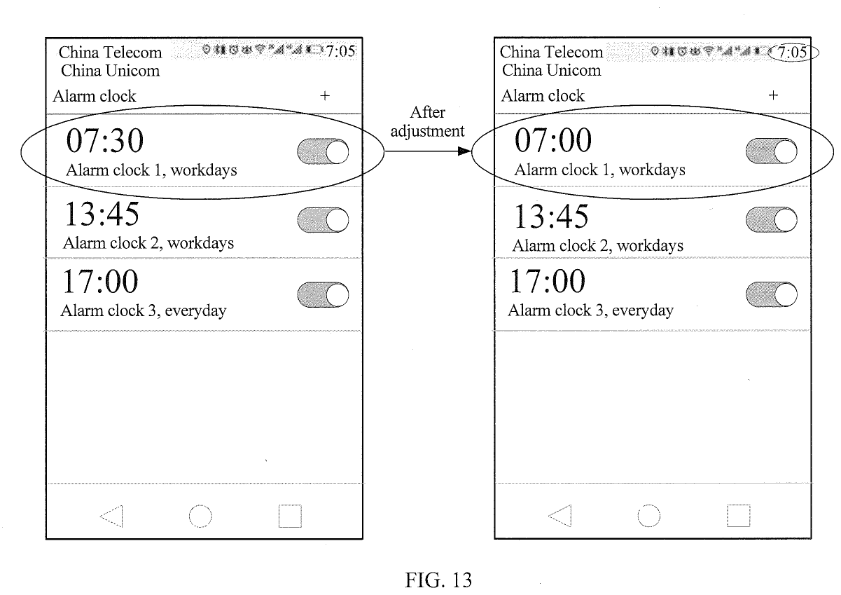

FIG. 10 and FIG. 12 show examples of scenarios in which weather becomes worse. After the start time of the alarm clock is adjusted based on a time adjustment value obtained in the scenario shown in FIG. 10, an adjusted start time is not earlier than a current time (as shown in FIG. 11), in other words, there is still time to adjust the start time of the alarm clock. After the start time of the alarm clock is adjusted based on a time adjustment value obtained in the scenario shown in FIG. 12, an adjusted start time is earlier than a current time (as shown in FIG. 13), in other words, there is no time to adjust the start time of the alarm clock. The following examples are separately used for description.

As shown in FIG. 10, after the notification message (a push time is 5:05) shown in FIG. 4, the weather application pushes a notification message (a push time is 6:05) shown in FIG. 10. In this case, keywords “7:00 on 12”, “Nanshan District”, and “moderate rain” are extracted from the notification message by using the lexis parser, and a time adjustment value is obtained based on these keywords. If the obtained time adjustment value is 20 min, the original start time (7:30) of the alarm clock 1 may be adjusted to 7:10, as shown in FIG. 11.

As shown in FIG. 12, after the notification message (the push time is 6:05) shown in FIG. 10, the weather application pushes a notification message (a push time is 7:05) shown in FIG. 12. In this case, keywords “8:00 on 12”, “Nanshan District”, and “rainstorm” are extracted from the notification message by using the lexis parser, and a time adjustment value is obtained based on these keywords. If the obtained time adjustment value is 30 min, the original start time (7:30) of the alarm clock 1 may be adjusted to 7:00. However, a current time is 7:05, and it is obvious that the adjusted start time is earlier than the current time, as shown in FIG. 13. In this case, the alarm clock should be immediately triggered.

When a notification message pushed by the weather application is received again, and it is learned, through parsing based on the lexis parser, that weather represented by the notification message becomes good, a time adjustment value is determined in any one of the foregoing implementations of determining a time adjustment value, and the start time of the alarm clock is adjusted.

In this application, the following examples may be used to describe manners of obtaining the target route.

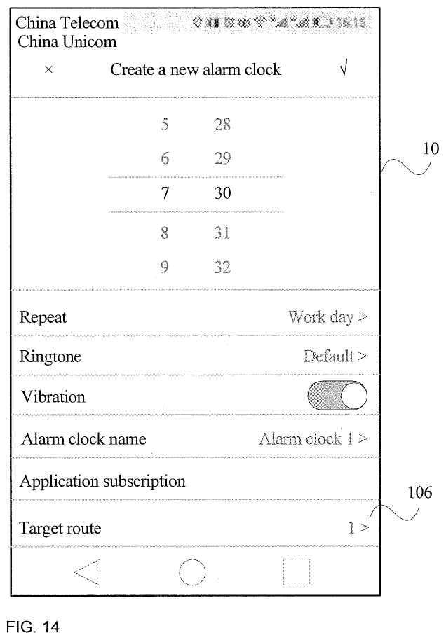

In a first implementation, as shown in FIG. 14, the target route may be entered in a new-alarm-clock creation interface 10.

Specifically, a column of a target route 106 may be newly added to the new-alarm-clock creation interface 10. As shown in FIG. 14, when creating a new alarm clock, the user directly enters the route 1 as the target route.

In a second implementation, the target route may be entered in a map application, and an alarm clock associated with the target route is specified.

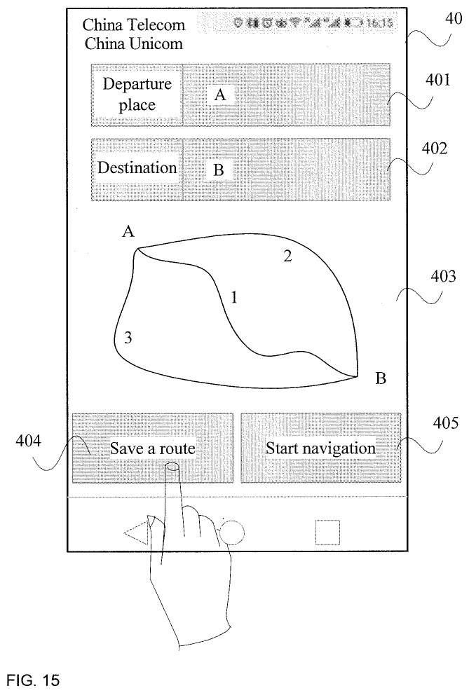

FIG. 15 is a schematic diagram of an example of setting a route. As shown in FIG. 15, a route setting interface 40 may include a departure place setting control 401, a destination setting control 402, a route generation interface 403, a route saving control 404, and a navigation start control 405. The departure place setting control 401 and the destination setting control 402 are respectively configured to receive a departure place and a destination that are entered by the user. The route generation interface 403 is configured to: generate at least one route based on the departure place and the destination that are entered by the user, and display the at least one route. The route saving control 404 is configured to receive a route saving operation entered by the user. The navigation start control 405 is configured to receive a navigation start instruction entered by the user. Specifically, when detecting, by using the route saving control 404, the route saving operation (for example, a tap operation) entered by the user, the system displays an alarm clock association interface 50.

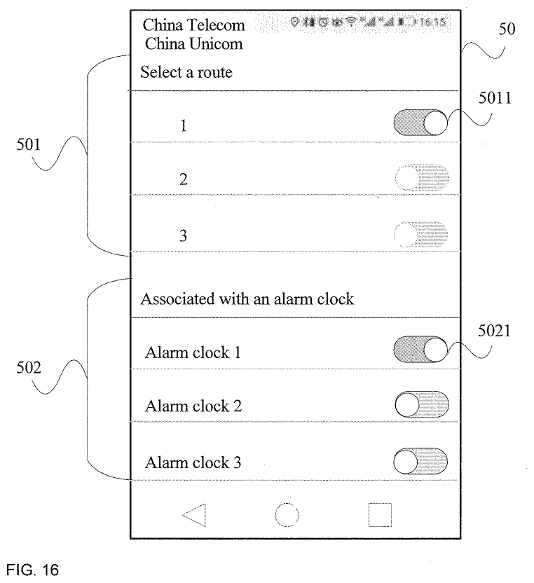

FIG. 16 is a schematic diagram of an example of associating an alarm clock. As shown in FIG. 16, the alarm clock association interface 50 may include a route selection interface 501 and an alarm clock selection interface 502. The route selection interface 501 is configured to receive a target route selection operation entered by the user. The target route is one of the at least one route generated based on the departure place and the destination. When the user selects one route as the target route, the user cannot enter an operation of selecting another route. The alarm clock selection interface 502 is configured to: after the target route is selected, receive a selection operation, entered by the user, of associating the target route with one or more alarm clocks.

Specifically, the target route selection operation entered by the user may be received by using a route selection control 5011 shown in FIG. 16. Specifically, when a button on a route selection control 5011 corresponding to each route is slid to the right, it indicates that the route is selected as the target route. A manner in which the user selects the route by operating the route selection control is not limited herein. In addition, the route selection control 5011 is not limited to being implemented as the route selection control shown in FIG. 16, and may use another control during actual application.

Specifically, an alarm clock association operation entered by the user may be received by using an alarm clock selection control 5021 shown in FIG. 16. Specifically, when a button on an alarm clock selection control 5021 corresponding to each alarm clock is slid to the right, it indicates that the alarm clock is selected as an alarm clock associated with the target route. A manner in which the user selects the alarm clock by operating the alarm clock selection control is not limited herein. In addition, the alarm clock selection control 5021 is not limited to being implemented as the alarm clock selection control shown in FIG. 16, and may use another control during actual application.

A control for receiving the selection operation entered by the user is not limited to the alarm clock selection control shown in FIG. 16, and may alternatively be another control that can receive the selection operation entered by the user. The selection operation entered for the alarm clock selection control 5021 is not limited to moving a movable button.

Optionally, after a plurality of routes are generated by entering a departure place A and a destination B in the route setting interface 40 shown in FIG. 15, a route with a shortest distance may alternatively be automatically selected as the target route, or a route in which the user most frequently traveled in the past is selected as the target route with reference to historical data of the user.

In a third implementation, the target route is obtained based on historical data of the user.

Specifically, it can be learned from FIG. 2A that the user usually sets more than one alarm clock. Therefore, a to-be-adjusted alarm clock needs to be first determined, and then the target route is obtained based on a start time of the to-be-adjusted alarm clock and with reference to the historical data of the user.

For example, the terminal may record daily travel information of the user. It is assumed that the user usually departs from A for B (for example, from home for a company) at about 8:00 a.m. Therefore, the to-be-adjusted alarm clock may be an alarm clock within a time period before 8:00 a.m. The time period may be, for example, half an hour or one hour. It can be learned that in the assumed application scenario, a to-be-adjusted alarm clock in FIG. 2A is the alarm clock 1 (the start time is 7:30). Therefore, a target route associated with the alarm clock 1 may be a route from A to B. In addition, there may be several routes from A to B, and a route in which the user most frequently travels may be selected as the target route based on a record.

In some embodiments of this application, a notification message provided by a traffic application is used as an example to describe how to adjust the start time of the alarm clock based on the notification message of the traffic application. The notification message is the first message.

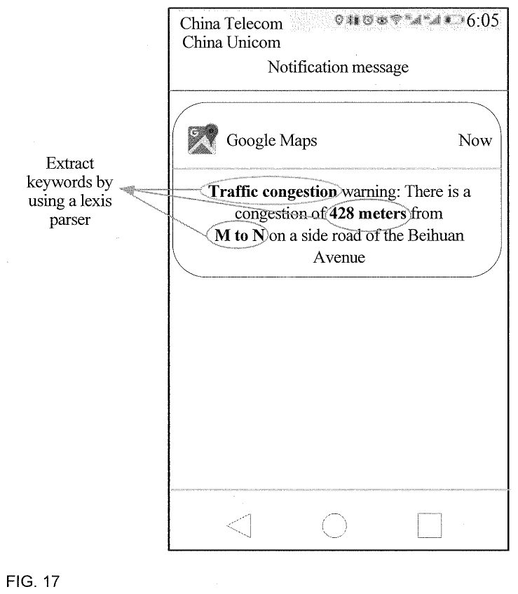

FIG. 17 shows an example of a notification message of a Google map application (which is referred to as a traffic application in subsequent embodiments and the accompanying drawings). As shown in FIG. 17, keywords such as “traffic congestion”, “M to N”, and “428 meters” may be extracted by using a lexis parser. It is assumed that a traffic congestion threshold is 100 meters, in other words, when a congestion length S is greater than 100 meters, the preset condition is met. In this case, an affecting factor represented by the extracted information shown in FIG. 17 meets the preset condition, in other words, the start time of the alarm clock needs to be adjusted based on the first message.

A time adjustment value of the start time may be specifically related to travel times in which the user travels in a route in different traffic congestion degrees. Herein, the travel route may be referred to as a target route. Specifically, different traffic congestion degrees may be indicated by using different congestion lengths, and a longer congestion length indicates a greater traffic congestion degree. Further, different traffic congestion degrees may be indicated by using different congestion length ranges. In addition to the traffic congestion length, different traffic congestion degrees may be indicated in another manner, for example, vehicle speeds. In this embodiment of this application, different congestion length ranges indicate different traffic congestion degrees.

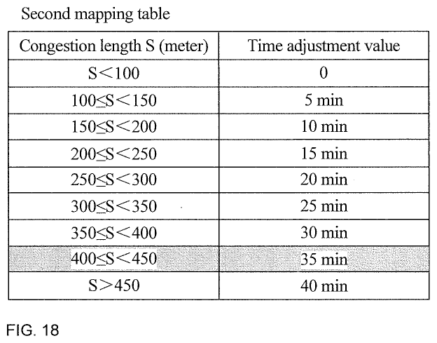

FIG. 18 shows an example of a second mapping table. As shown in FIG. 18, a time adjustment value corresponding to a traffic congestion length represented by traffic information included in the first message may be determined by using the second mapping table. The time adjustment value represents a degree to which the traffic congestion length represented by the traffic information affects the start time of the alarm clock. The alarm clock application may adjust the start time of the alarm clock based on the time adjustment value. Specifically, after a keyword is extracted, the traffic congestion length represented by the traffic information is determined, and the time adjustment value corresponding to the traffic congestion length is searched for according to the second mapping table. For example, a traffic congestion length represented by the notification message shown in FIG. 17 is 428 meters, and it may be found, according to the second mapping table shown in FIG. 18, that a time adjustment value corresponding to a length range 400≤S<450 to which the traffic congestion length 428 meters belongs is 35 min.

Further, a time adjustment value of the start time may be specifically related to travel times in which the user travels in a route in different traffic congestion length ranges. Herein, the travel route may be referred to as a target route.

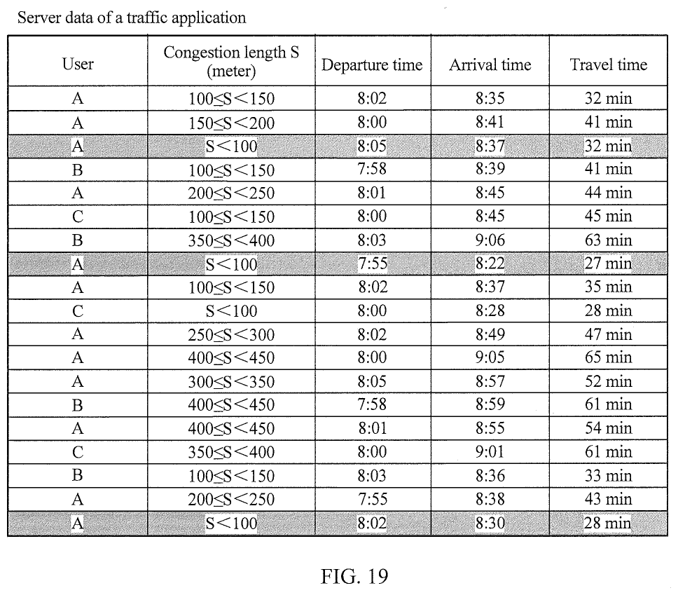

FIG. 19 shows an example of server data of a traffic application. As shown in FIG. 19, the server data of the traffic application may include travel times in which different users travel in the target route in different congestion length ranges. In this application, travel times in which a specific user travels in the target route in different congestion length ranges may be obtained through matching by using the server data of the traffic application.

It is assumed that the user is a user A in FIG. 19, the alarm clock is the alarm clock 1 (the start time is 7:30) shown in FIG. 1, and a notification message pushed by the traffic application is the notification message shown in FIG. 17. Specifically, the time adjustment value of the start time may be determined based on the server data of the traffic application in the following manners.

In a first implementation, it is assumed that the start time 7:30 is set by the user based on a travel time in a good traffic condition. In a case of different congestion lengths, the time adjustment value may be a difference between a travel time of traveling in the target route in each congestion length range and the travel time of traveling in the target route in a good traffic condition. The travel time in which the user travels in the target route in each congestion length range may be an average value of a plurality of travel times.

Optionally, the time adjustment value of the start time may be determined based on historical data of the user. In this case, the time adjustment value is determined in the following several steps.

First, an average value of travel times required for the user A to travel in the target route in a good traffic condition is calculated. It is assumed that the good traffic condition means that a congestion length is less than 100 meters. In data shown in FIG. 19, the travel times in a good traffic condition are respectively 32 min, 27 min, and 28 min, and therefore the obtained average value is 29 min. Therefore, a travel time in which the user A travels in the target route in a good traffic condition is 29 min.

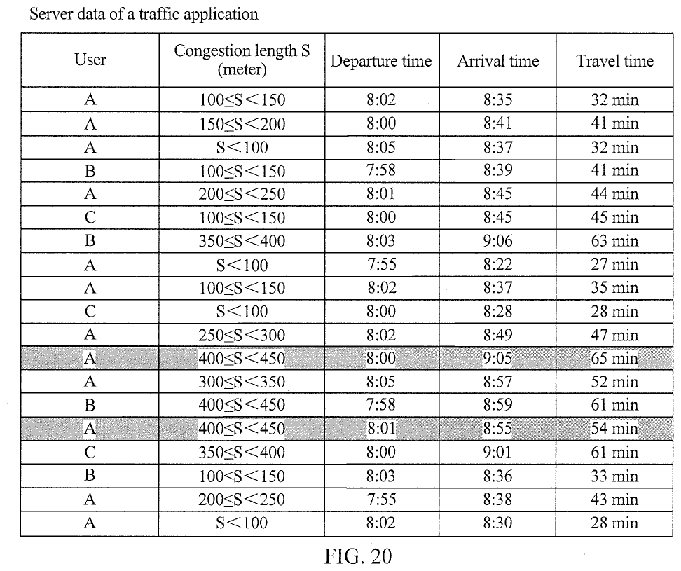

Then, a congestion length range to which a traffic congestion length represented by the notification message belongs is determined, and an average value of travel times in which the user A travels in the target route in the congestion length range is calculated. The congestion length range to which the congestion length 428 meters represented by the notification message shown in FIG. 17 belongs is 400≤S<450. Data in gray parts in FIG. 20 shows that, the travel times in which the user A travels in the target route in the congestion length range are 65 min and 54 min, and therefore the obtained average value is 60 min. Therefore, when the congestion length range is 400≤S<450, a travel time of traveling in the target route is 60 min.

Finally, when the congestion length range is 400≤S<450, the adjustment value of the start time of the alarm clock is determined based on the travel time in which the user A travels in the target route in a good traffic condition and the travel time required to travel in the target route when the congestion length range is 400≤S<450. The time adjustment value corresponding to the congestion length range 400≤S<450 is a difference between the travel time required for the user A to travel in the target route in a good traffic condition and the travel time required to travel in the target route when the congestion length range is 400≤S<450, that is, 60−29=31 min.

Optionally, the time adjustment value of the start time may be determined based on historical data of all users. In this case, the time adjustment value is determined in the following several steps.

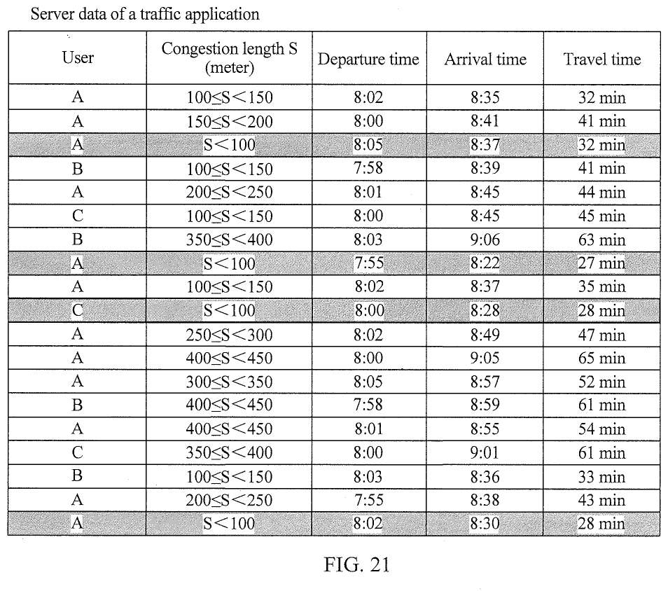

First, an average value of travel times required for all the users to travel in the target route in a good traffic condition is calculated. It is assumed that the good traffic condition means that a congestion length is less than 100 meters. In data shown in FIG. 21, the travel times in a good traffic condition are respectively 32 min, 27 min, 28 min, and 28 min, and therefore the obtained average value is 29 min. Therefore, a travel time in which all the users travel in the target route in a good traffic condition is 29 min.

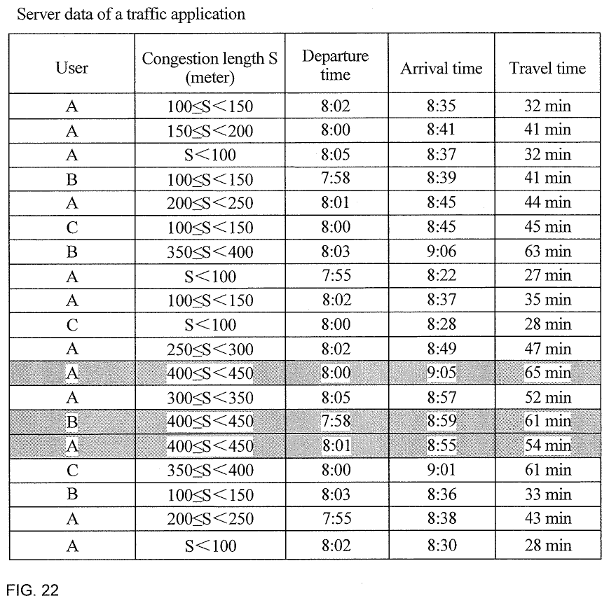

Then, a congestion length range to which a congestion length represented by the notification message belongs is determined, and an average value of travel times in which all the users travel in the target route in the congestion length range is calculated. The congestion length range to which the congestion length 428 meters represented by the notification message shown in FIG. 17 belongs is 400≤S<450. Data in gray parts in FIG. 22 shows that, the travel times in which all the users travel in the target route in the congestion length range are 65 min, 61 min, and 54 min, and therefore the obtained average value is 60 min. Therefore, when the congestion length range is 400≤S<450, a travel time of traveling in the target route is 60 min.

Finally, when the congestion length range is 400≤S<450, the adjustment value of the start time of the alarm clock is determined based on the travel time required for all the users to travel in the target route in a good traffic condition and the travel time required to travel in the target route when the congestion length range is 400≤S<450. The time adjustment value corresponding to the congestion length range 400≤S<450 is a difference between the travel time required for all the users to travel in the target route in a good traffic condition and the travel time required to travel in the target route when the congestion length range is 400≤S<450, that is, 60−29=31 min.

In a second implementation, different ranges of travel times of traveling in the target route and time adjustment values corresponding to the different ranges are preset. As shown in FIG. 8, four ranges of travel times t may be set t≤40 min, 40 min<t≤50 min, 50 min<t≤60 min, and t>60 min. The four ranges respectively correspond to the following time adjustment values: 0, 10 min, 20 min, and 30 min. A travel time in which the user travels in the target route in each congestion length range may be an average value of a plurality of travel times.

Similarly, travel times of traveling in the target route in different congestion length ranges may be determined based on historical data of the user or historical data of all users. In an example, the travel times of traveling in the target route in the different congestion length ranges are determined based on the historical data of the user. In this case, the time adjustment value is determined in the following several steps.

First, a congestion length range to which a congestion length represented by the notification message belongs is determined, and an average value of travel times in which the user A travels in the target route in the congestion length range is calculated. The congestion length range to which the congestion length 428 meters represented by the notification message shown in FIG. 17 belongs is 400≤S<450. Data in gray parts in FIG. 20 shows that, the travel times in which the user A travels in the target route in the congestion length range are 65 min and 54 min, and therefore the obtained average value is 60 min. Therefore, when the congestion length range is 400≤S<450, a travel time of traveling in the target route is 60 min.

Then, a travel time range to which the travel time belongs in a preset mapping table is determined based on the travel time in which the user A travels in the target route in the congestion length range. It can be known, from the preset mapping table shown in FIG. 8, that when the congestion length range is 400≤S<450, the range to which the travel time in which the user A travels in the target route belongs is 50 min<t≤60 min.

Finally, a time adjustment value corresponding to the travel time range is searched for according to the preset mapping table. It may be determined, according to the preset mapping table shown in FIG. 8, that the time adjustment value corresponding to the travel time range is 30 min, in other words, when the congestion length is 428 meters, the time adjustment value required for the user A to travel in the target route is 30 min.

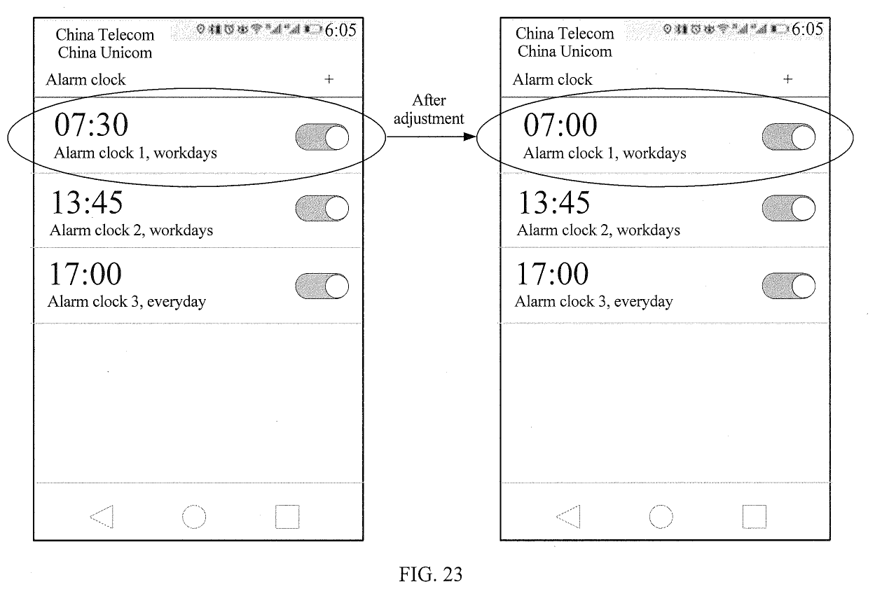

FIG. 23 shows an example of adjusting a start time of an alarm clock. As shown in FIG. 23, if it is determined, in any one of the foregoing manners, that the time adjustment value is 30 min, the start time of the alarm clock is adjusted based on the time adjustment value, in other words, the start time 7:30 of the alarm clock 1 may be adjusted to 7:00.

In some possible scenarios, the notification message pushed by the traffic application may change, in other words, a traffic congestion degree becomes greater or smaller. Subsequently, an example in which the traffic congestion degree becomes smaller is used for description.

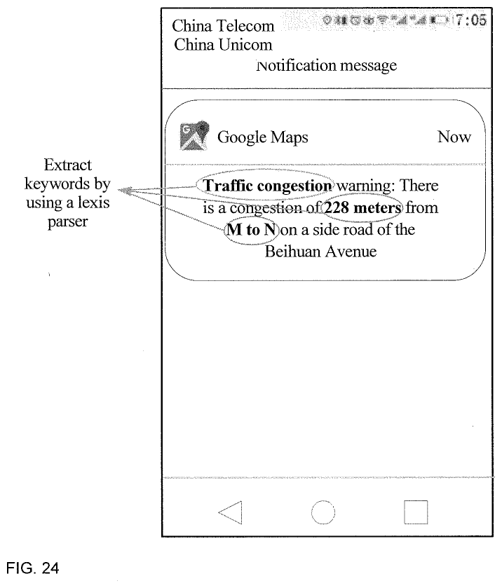

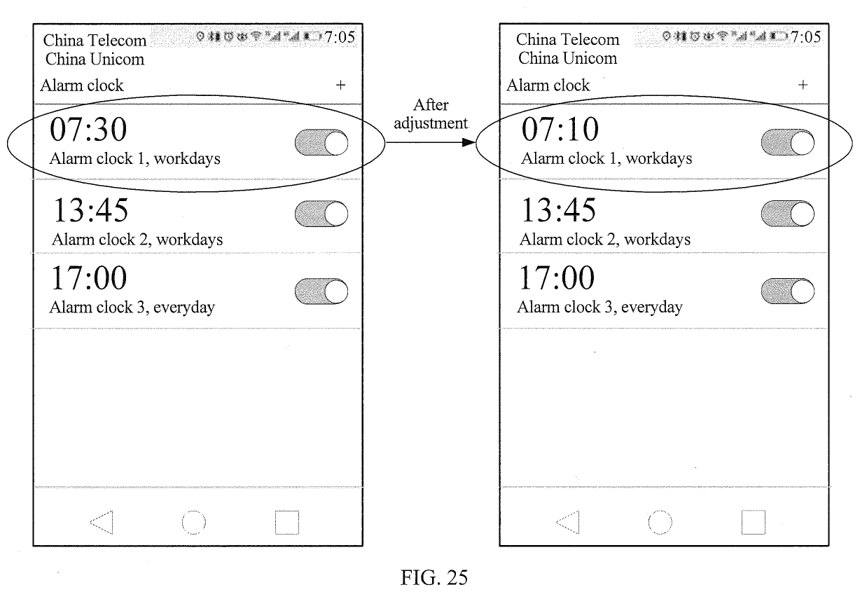

FIG. 24 shows an example of a scenario in which a traffic congestion degree becomes smaller. As shown in FIG. 24, after the notification message (a push time is 6:05) shown in FIG. 17, the traffic application pushes a notification message (a push time is 7:05) shown in FIG. 24. In this case, keywords “traffic congestion”, “M to N”, and “228 meters” are extracted from the notification message by using the lexis parser, and a time adjustment value is obtained based on these keywords. If the obtained time adjustment value is 20 min, the original start time (7:30) of the alarm clock 1 may be adjusted to 7:10, as shown in FIG. 25.

In a possible scenario, after the start time of the alarm clock is adjusted based on the time adjustment value obtained based on the notification message pushed by the traffic application, an obtained adjusted start time is earlier than a current time. In this case, the alarm clock should be immediately triggered.

In this application, a manner of obtaining the target route is consistent with the manner of obtaining the target route described in the weather embodiment. Details are not described herein again.

In this application, after the notification message of the traffic application is received, traffic represented by the notification message can affect an alarm clock only after a time period, in other words, the notification message can be associated with an alarm clock only after a time period. The time period may be, for example, two hours or one hour. In an example, the time period is two hours. A notification message of the traffic application is received at 6:00, and after a time adjustment value is obtained based on the notification message, a start time of only an alarm clock whose start time is after 6:00 and before 8:00 can be adjusted. For example, it may be learned from FIG. 17 that a current time at which the notification message of the traffic application is received is 6:05, and it may be learned that the notification message can be associated with only the alarm clock 1, in other words, traffic represented by the notification message may affect the start time of the alarm clock 1. Therefore, after the time adjustment value 30 min is obtained, the start time of the alarm clock 1 may be adjusted from 7:30 to 7:00, as shown in FIG. 23.

In some embodiments of this application, in addition to factors such as weather and traffic that may affect the start time of the alarm clock, there are some events that may affect the start time of the alarm clock, for example, an emergency event (for example, a meeting) notified by a short message service application, an email application, or the like, and a to-do event notified by a calendar application, a memo application, or the like. Subsequently, a notification message (namely, the first message) provided by an email application is used as an example to describe how to adjust the start time of the alarm clock based on the notification message of the email application.

If the terminal receives a notification message pushed by the email application, and keywords extracted from the notification message by using a lexis parser are “13:30 today,” “at a company meeting room,” and “have a meeting,” it may be learned, through analysis, that a current event is “have a meeting,” an occurrence time of the event is “13:30 today,” and an occurrence position of the event is “a company meeting room.” A time adjustment value may be determined in the following several steps and based on the keywords extracted by using the lexis parser.

First, an alarm clock associated with the event is determined. An alarm clock that is within a first threshold before the occurrence time and a second threshold after the occurrence time is determined, based on the occurrence time of the event, as the alarm clock associated with the event. For example, the first threshold may be 30 min, and the second threshold may be 40 min. In this case, a time range from the first threshold before the occurrence time (13:30 today) of the event to the second threshold after the occurrence time is 13:00 to 14:10, and an alarm clock 2 (a start time is 13:45) in FIG. 3 may be associated.

Then, a relationship between the occurrence time of the event and a start time of the associated alarm clock is determined, in other words, it is determined whether the occurrence time of the event is earlier or later than the start time of the alarm clock.

Finally, the time adjustment value is determined based on the relationship between the occurrence time of the event and the start time of the associated alarm clock.

If the occurrence time of the event is earlier than the start time of the alarm clock, the time adjustment value is at least a difference between the start time and the occurrence time. The terminal may obtain current position information of the user by using a GPS or in another manner, and calculates a distance between a current position of the user and the occurrence position of the event. If the distance is less than a specific threshold, the time adjustment value may be the difference between the start time and the occurrence time. If the distance is not less than a specific threshold, the time adjustment value may be a sum of the difference and a preparation time. The specific threshold may be, for example, 300 meters or 500 meters. The preparation time may be a time required for going from the current position of the user to the occurrence position of the event in this case, for determining of the preparation time, refer to determining of the time adjustment value in the weather embodiment, the traffic embodiment, or the weather and traffic embodiment.

If the occurrence time of the event is not earlier than the start time of the alarm clock, the time adjustment value may be determined by a relationship between a preparation time and a difference between the start time and the occurrence time of the event. In subsequent description, the difference between the start time and the occurrence time of the event is referred to as a first time interval.

When the preparation time is greater than the first time interval, the time adjustment value is at least a difference between the preparation time and the first time interval. For example, if the occurrence time of the event is 14:00, and the start time of the alarm clock associated with the event is 13:45, the first time interval is 15 min. If the preparation time is 30 min, the preparation time is greater than the first time interval in this case. Therefore, the time adjustment value is 30−15=15 min, in other words, the start time 13:45 of the alarm clock is adjusted to 13:30.

When the preparation time is not greater than the first time interval, the time adjustment value is 0. For example, if the occurrence time of the event is 14:00, and the start time of the alarm clock associated with the event is 13:45, the first time interval is 15 min. If the preparation time is 10 min, the preparation time is not greater than the first time interval in this case. Therefore, the time adjustment value is 0, in other words, the start time of the alarm clock is not adjusted.

In some embodiments of this application, the affecting factor may include two factors: weather and traffic. For example, a notification message of a weather application and a notification message of a traffic application are successively or simultaneously pushed to a notification bar of the terminal. It is assumed that both the notification message of the weather application and the notification message of the traffic application affect the start time of the alarm clock. Subsequently, an example in which the notification message of the weather application is received before the notification message of the traffic application is used for description.

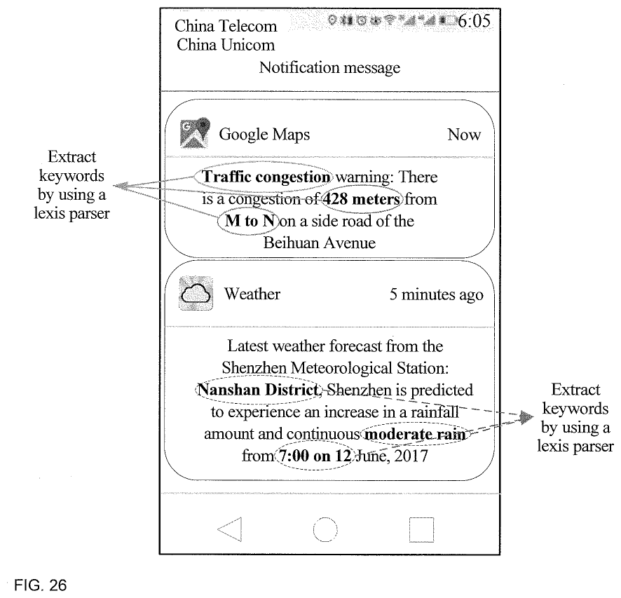

FIG. 26 shows an example of a notification message of a weather application and a notification message of a traffic application. As shown in FIG. 26, keywords “7:00 on 12”, “Nanshan District”, “moderate rain”, “traffic congestion”, “M to N”, and “428 meters” may be extracted by using a lexis parser. It is assumed that first weather is non-sunny, and a traffic congestion threshold is 100 meters. Affecting factors represented by the extracted information shown in FIG. 26 meet the preset condition, in other words, the start time of the alarm clock needs to be adjusted based on the first message.

A time adjustment value of the start time may be specifically related to travel times in which the user travels in a route in different weather and in different traffic congestion degrees. Herein, the travel route may be referred to as a target route. Specifically, different traffic congestion degrees may be indicated by using different congestion lengths, and a longer congestion length indicates a greater traffic congestion degree. Further, different traffic congestion degrees may be indicated by using different congestion length ranges. In addition to the traffic congestion length, different traffic congestion degrees may be indicated in another manner, for example, vehicle speeds. In this embodiment of this application, different congestion length ranges indicate different traffic congestion degrees.

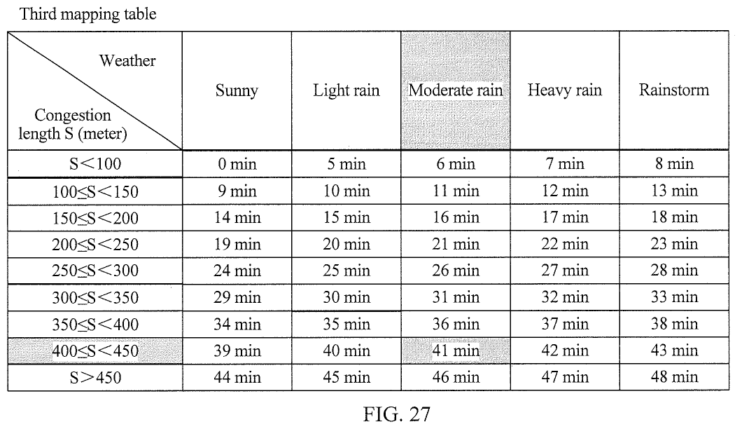

FIG. 27 shows an example of a third mapping table. As shown in FIG. 27, a time adjustment value corresponding to weather and a traffic congestion length that are represented by the first message may be determined by using the third mapping table. The time adjustment value represents a degree to which the weather and the traffic congestion length that are represented by the first message affect the start time of the alarm clock. The alarm clock application may adjust the start time of the alarm clock based on the time adjustment value. Specifically, after a keyword is extracted, the weather and the traffic congestion length that are represented by the first message are determined, and the time adjustment value corresponding to the weather and the traffic congestion length is searched for according to the third mapping table. For example, weather represented by the notification message in FIG. 26 is moderate rain, and a traffic congestion length is 428 meters. In this case, it may be found, according to the third mapping table in FIG. 27, that a time adjustment value corresponding to moderate rain and the traffic congestion length 428 meters (a congestion length range is 400≤S<450) is 41 min.

Further, a time adjustment value of the start time may be specifically related to travel times in which the user travels in a route in different weather and in different traffic congestion lengths. Herein, the travel route may be referred to as a target route.

FIG. 28 shows an example of server data of a weather application and a traffic application. As shown in FIG. 28, the server data of the weather application and the traffic application may include travel times in which different users travel in the target route in different weather and in different congestion length ranges.

It is assumed that the user is a user A in FIG. 28, the alarm clock is the alarm clock 1 (the start time is 7:30) shown in FIG. 1, and notification messages pushed by the weather application and the traffic application are the notification messages shown in FIG. 26. Specifically, the time adjustment value of the start time may be determined based on the server data of the traffic application in the following manners.

In a first implementation, it is assumed that the start time 7:30 is set by the user based on a travel time on a sunny day and in a good traffic condition. In a case of different severe weather and different congestion lengths, the time adjustment value may be a difference between a travel time of traveling in the target route in each severe weather and in each congestion length range and the travel time of traveling in the target route on a sunny day and in a good traffic condition. The travel time in which the user travels in the target route in each severe weather and in each congestion length range may be an average value of a plurality of travel times.

Optionally, the time adjustment value of the start time may be determined based on historical data of the user. In this case, the time adjustment value is determined in the following several steps.

First, an average value of travel times required for the user A to travel in the target route on a sunny day and in a good traffic condition is calculated. It is assumed that the good traffic condition means that a congestion length is less than 100 meters. In data shown in FIG. 28, the travel times in which the user A travels in the target route on a sunny day and in a good traffic condition are respectively 32 min, 27 min, and 28 min, and therefore the obtained average value is 29 min. Therefore, a travel time required for the user A to travel in the target route on a sunny day and in a good traffic condition is 29 min.

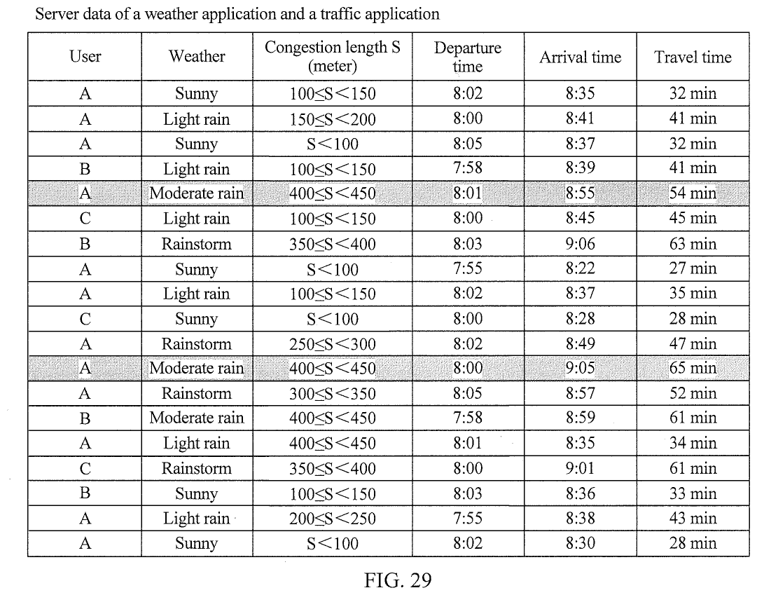

Then, a congestion length range to which a traffic congestion length represented by the notification message belongs is determined, and an average value of travel times in which the user A travels in the target route in the weather and in the congestion length range is calculated. Weather represented by the notification message in FIG. 26 is moderate rain, and the congestion length range to which the represented traffic congestion length 428 meters belongs is 400≤S<450. Data in gray parts in FIG. 29 shows that, the travel times in which the user A travels in the target route in the weather and in the congestion length range are 54 min and 65 min, and therefore the obtained average value is 60 min. Therefore, when the weather is moderate rain, and the congestion length range is 400≤S<450, a travel time of traveling in the target route is 60 min.

Finally, when the weather is moderate rain and the congestion length range is 400≤S<450, the adjustment value of the start time of the alarm clock is determined based on the travel time required for the user A to travel on a sunny day and in a good traffic condition and the travel time required to travel in the target route when the weather is moderate rain and the congestion length range is 400≤S<450. The time adjustment value corresponding to moderate rain and the congestion length range 400≤S<450 is a difference between the travel time required for the user A to travel in the target route when the weather is moderate rain and the congestion length range is 400≤S<450 and the travel time of traveling in the target route on a sunny day and in a good traffic condition, that is, 60−29=31 min.

Optionally, the time adjustment value of the start time may be determined based on historical data of all users. In this case, the time adjustment value is determined in the following several steps.

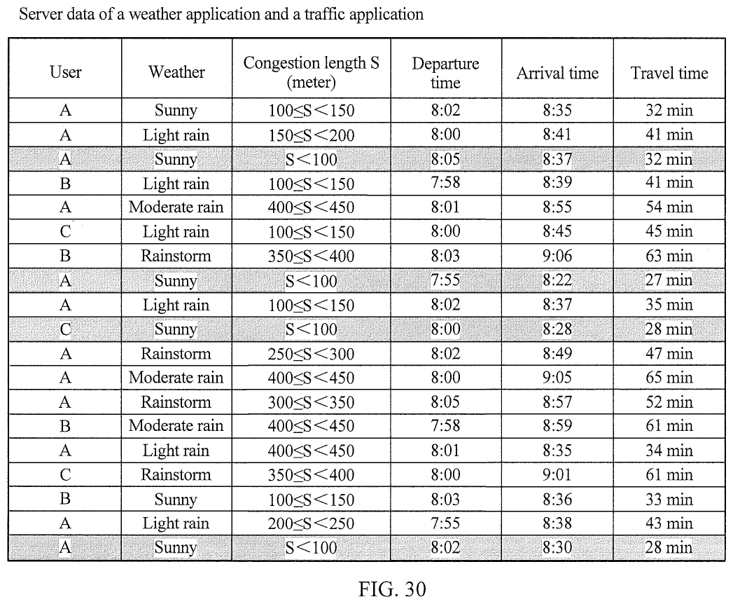

First, an average value of travel times required for all the users to travel in the target route on a sunny day and in a good traffic condition is calculated. It is assumed that the good traffic condition means that a congestion length is less than 100 meters. In data shown in FIG. 30, the travel times required for all the users to travel in the target route on a sunny day and in a good traffic condition are respectively 32 min, 27 min, 28 min, and 28 min, and therefore the obtained average value is 29 min. Therefore, a travel time in which all the users travel in the target route on a sunny day and in a good traffic condition is 29 min.

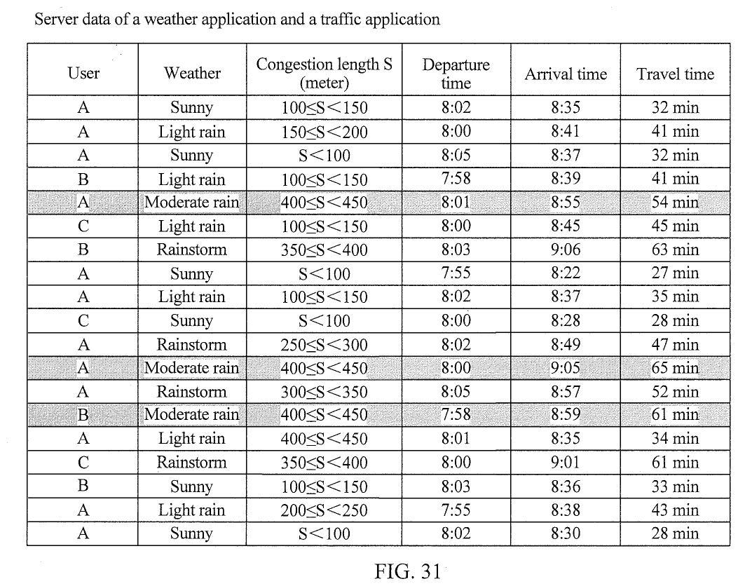

Then, a congestion length range to which a traffic congestion length represented by the notification message belongs is determined, and an average value of travel times in which all the users travel in the target route in the weather and in the congestion length range is calculated. Weather represented by the notification message in FIG. 26 is moderate rain, and the congestion length range to which the represented traffic congestion length 428 meters belongs is 400≤S<450. Data in gray parts in FIG. 31 shows that, the travel times in which all the users travel in the target route in the weather and in the congestion length range are 54 min, 61 min, and 65 min, and therefore the obtained average value is 60 min. Therefore, when the weather is moderate rain, and the congestion length range is 400≤S<450, a travel time of traveling in the target route is 60 min.

Finally, when the weather is moderate rain and the congestion length range is 400≤S<450, the adjustment value of the start time of the alarm clock is determined based on the travel time required for all the users to travel in the target route on a sunny day and in a good traffic condition and the travel time required to travel in the target route when the weather is moderate rain and the congestion length range is 400≤S<450. The time adjustment value corresponding to moderate rain and the congestion length range 400≤S<450 is a difference between the travel time required for the user A to travel in the target route when the weather is moderate rain and the congestion length range is 400≤S<450 and the travel time of traveling in the target route on a sunny day and in a good traffic condition, that is, 60−29=31 min.

In a second implementation, different ranges of travel times of traveling in the target route and time adjustment values corresponding to the different ranges are preset. As shown in FIG. 8, four ranges of travel times t may be set: t≤40 min, 40 min<t≤50 min, 50 min<t≤60 min, and t>60 min. The four ranges respectively correspond to the following time adjustment values: 0, 10 min, 20 min, and 30 min. A travel time in which the user travels in the target route in each congestion length range may be an average value of a plurality of travel times.

Similarly, travel times of traveling in the target route in different weather and in different congestion lengths may be determined based on historical data of the user or historical data of all users. In an example, the travel times of traveling in the target route in the different weather and in the different congestion lengths are determined based on the historical data of the user. In this case, the time adjustment value is determined in the following several steps.

First, a congestion length range to which a traffic congestion length represented by the notification message belongs is determined, and an average value of travel times in which the user A travels in the target route in the weather and in the congestion length range is calculated. Weather represented by the notification message in FIG. 26 is moderate rain, and the congestion length range to which the represented traffic congestion length 428 meters belongs is 400≤S<450. Data in gray parts in FIG. 29 shows that, the travel times in which the user A travels in the target route in the weather and in the congestion length range are 54 min and 65 min, and therefore the obtained average value is 60 min. Therefore, when the weather is moderate rain, and the congestion length range is 400≤S<450, a travel time of traveling in the target route is 60 min.

Then, a travel time range to which the travel time belongs in a preset mapping table is determined based on the travel time in which the user A travels in the target route in the weather and in the congestion length range. It can be known, from the preset mapping table shown in FIG. 8, that when the weather is moderate rain, and the congestion length range is 400≤S<450, the range to which the travel time in which the user A travels in the target route belongs is 50 min<t≤60 min.

Finally, a time adjustment value corresponding to the travel time range is searched for according to the preset mapping table. It may be determined, according to the preset mapping table shown in FIG. 8, that the time adjustment value corresponding to the travel time range is 30 min, in other words, when the weather is moderate rain, and the congestion length is 428 meters, the time adjustment value required for the user A to travel in the target route is 30 min.

Adjustment of the start time of the alarm clock is consistent with adjustment of the start time of the alarm clock shown in FIG. 23. Details are not described herein again.

In some possible scenarios, the notification message pushed by the weather application or the traffic application may change. For a process of determining a time adjustment value after the change, refer to related parts in the weather embodiment and the traffic embodiment.

In a possible scenario, after the start time of the alarm clock is adjusted based on the time adjustment value obtained based on the notification message pushed by the weather application and the notification message pushed by the traffic application, an obtained adjusted start time is earlier than a current time. In this case, the alarm clock should be immediately triggered.

In this application, a manner of obtaining the target route is consistent with the manner of obtaining the target route described in the foregoing embodiment. Details are not described herein again.

In this application, after the notification message of the traffic application is received, traffic represented by the notification message can affect an alarm clock only after a time period, in other words, the notification message can be associated with an alarm clock only after a time period. The time period may be, for example, two hours or one hour. In an example, the time period is two hours. A notification message of the traffic application is received at 6:00, and after a time adjustment value is obtained based on the notification message and with reference to the notification message of the weather application, a start time of only an alarm clock whose start time is after 6:00 and before 8:00 can be adjusted. For example, it may be learned from FIG. 27 that a current time at which the notification message of the traffic application is received is 6:05, and it may be learned that the notification message can be associated with only the alarm clock 1. In other words, traffic represented by the notification message may affect the start time of the alarm clock 1. Therefore, after the time adjustment value 30 min is obtained, the start time of the alarm clock 1 may be adjusted from 7:30 to 7:00, as shown in FIG. 23.

In some embodiments of this application, in addition to two factors: weather and traffic, the affecting factor may further include an event. An occurrence time of the event falls within a time range associated with the start time of the alarm clock.

After a first message is received, a keyword may be extracted first based on a lexis parser to obtain, through analysis, weather represented by weather information included in the first message, a traffic congestion degree represented by traffic information, and an occurrence time of an event represented by event information; then a time adjustment value is determined; and finally the start time of the alarm clock is adjusted based on the time adjustment value. The time adjustment value may be determined in the following implementations.

It s assumed that, the weather information included in the first message is provided by a weather application, the traffic information included in the first message is provided by a Google map application, and the event information included in the first message is provided by an email application.

In a first implementation, the time adjustment value corresponding to the weather condition, traffic, and the event may be determined according to a fourth mapping table. The fourth mapping table may include time adjustment values corresponding to relationships between the start time of the alarm clock and different weather, different traffic congestion degrees, and different event occurrence times. For a specific determining process, refer to the process of determining the time adjustment value according to the first mapping table in the weather embodiment, the process of determining the time adjustment value according to the second mapping table in the traffic embodiment, or the process of determining the time adjustment value according to the third mapping table in the weather and traffic embodiment Details are not described herein again.

In a second implementation, the time adjustment value may be determined based on integrated server data of the weather application, the Google map application, and the email application. The integrated server data may include historical data of different users in relationships between the start time of the alarm clock and different weather, different traffic congestion degrees, and different event occurrence times. For a specific determining process, refer to the process of determining the time adjustment value based on the server data of the weather application in the weather embodiment, the process of determining the time adjustment value based on the server data of the traffic application in the traffic embodiment, or the process of determining the time adjustment value based on the server data of the weather application and the traffic application in the weather and traffic embodiment. Details are not described herein again.

Method embodiment: An alarm clock adjustment method in this application is described subsequently based on all the foregoing embodiments.

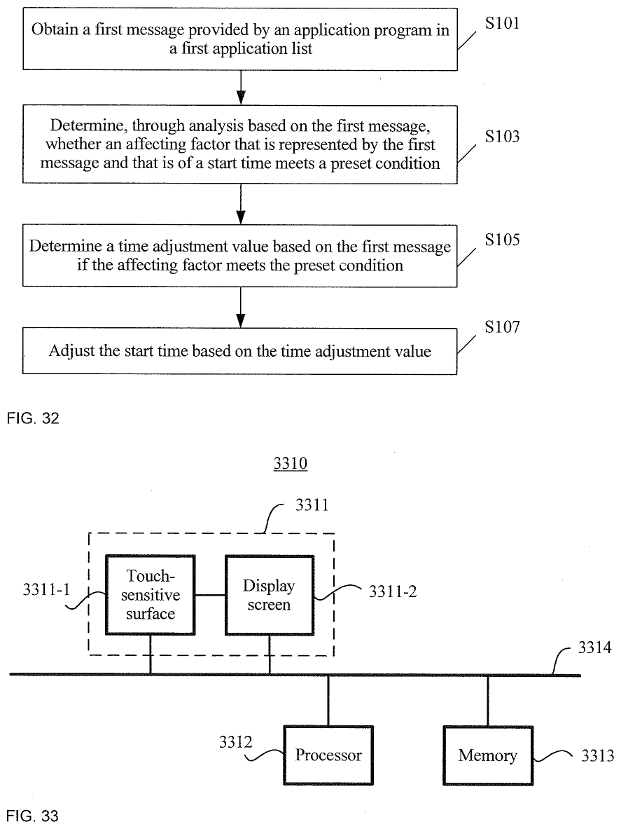

FIG. 32 is a flowchart of an alarm clock adjustment method according to an embodiment of the present invention. As shown in FIG. 32, the alarm clock adjustment method may include at least the following several steps.

S101. Obtain a first message of an application program in a first application list.

Specifically, the first application list is a list of applications to which a user subscribes. The first application list includes one or more application programs that can provide a first message and to which the user subscribes. After the user subscribes to an application, an alarm clock application may obtain a first message provided by the application.

Specifically, the first message may be obtained in the following manners.

In a first manner, the first message may be obtained by listening to a notification bar of a system.

For example, in an Android system, a first message pushed by an application to a notification bar may be obtained by using a NotificationListenerService mechanism.

Specifically, in the Android system, all notification messages pushed to the notification bar may be obtained by using the NotificationListenerService mechanism. Each time a notification message is obtained, an identifier of a source application of the notification message may be compared with identifiers of all source applications in the first application list. If the identifier of the source application of the notification message is consistent with an identifier of a source application in the first application list, subsequent processing is performed on the notification message. If the identifier of the source application of the notification message is consistent with none of the identifiers of all the source applications, no processing is performed on the notification message.

The example is merely an implementation provided in this application. When a notification message is pushed to a terminal, the alarm clock application may alternatively obtain, in another manner, content of messages pushed by all the applications in the first application list to the notification bar.

In a second manner, the first message may be requested from a server of the application program in the first application list.

Specifically, the alarm clock application may be authorized on the server of the application program in the first application list. When the alarm clock application requests the first message from the server of the application program in the first application list, the server of the application program in the first application list may detect whether a source identifier of the alarm clock application is consistent with a source identifier of an authorized application. If the source identifier of the alarm clock application is consistent with the source identifier of the authorized application, the alarm clock application is allowed to obtain the first message from the server of the application program in the first application list.

S103. Determine, through analysis based on the first message, whether an affecting factor that is represented by the first message and that is of a start time meets a preset condition.

Specifically, the affecting factor may include at least one of weather, traffic, or an event.

When the affecting factor is the weather, whether weather represented by weather information included in the first message is consistent with first weather is determined. If the weather represented by the weather information is consistent with the first weather, the weather represented by the first message meets the preset condition. The first weather may be severe weather, for example, weather such as light rain, moderate rain, heavy rain, rainstorm, thundershower, sleet, light snow, or heavy snow that may cause travel inconvenience to people.

When the affecting factor is the traffic, whether a traffic congestion degree represented by traffic information included in the first message is greater than a traffic congestion threshold is determined. If yes, traffic represented by the first message meets the preset condition. The traffic congestion degree may be indicated by using a traffic congestion length range.

When the affecting factor is the event, whether an occurrence time of an event represented by event information included in the first message falls within a time range associated with the start time of an alarm clock is determined. The preset condition is met if the occurrence time of the event is earlier than the start time and if a difference obtained by subtracting the occurrence time of the event from the start time is less than a first threshold. The preset condition is met if the start time is earlier than the occurrence time of the event and if a difference obtained by subtracting the start time from the occurrence time of the event is less than a second threshold.

When the affecting factor is at least two of the weather, the traffic, and the event, whether a combination of the at least two factors included in the first message belongs to a first set may be determined. The preset condition is met if the combination of the at least two factors belongs to the first set. The first set includes the combination of the at least two factors. Weather in each combination is consistent with first weather, a traffic congestion degree in each combination is greater than a traffic congestion threshold, and an occurrence time of an event in each combination falls within a time range associated with the start time of an alarm clock.

S105. Determine a time adjustment value based on the first message if the affecting factor meets the preset condition.

When the affecting factor is the weather, the time adjustment value is determined based on the first message in the following two manners.

In a first manner, a time adjustment value corresponding to the weather represented by the weather information included in the first message may be determined according to a first mapping table. The first mapping table includes time adjustment values respectively corresponding to different weather. For details of the first implementation, refer to the embodiment in FIG. 5. Details are not described herein again.

In a second manner, the time adjustment value may be determined based on server data of a weather application. The server data of the weather application includes travel times in which different users travel in different routes in different weather. For details of the second implementation, refer to the embodiment in FIG. 6 to FIG. 8. Details are not described herein again.

When the affecting factor is the traffic, the time adjustment value is determined based on the first message in the following two manners.

In a first manner, a time adjustment value corresponding to the traffic represented by the traffic information included in the first message may be determined according to a second mapping table. The second mapping table includes time adjustment values respectively corresponding to different traffic congestion length ranges. For details of the first implementation, refer to the embodiment in FIG. 18. Details are not described herein again.

In a second manner, the time adjustment value may be determined based on server data of a traffic application. The server data of the traffic application includes travel times in which different users travel in a target route in different congestion length ranges. For details of the second implementation, refer to the embodiment in FIG. 19 to FIG. 22. Details are not described herein again.

When the affecting factor is the event, the time adjustment value is determined based on a relationship between the occurrence time of the event and the start time of the alarm clock. When the occurrence time is earlier than the start time, the time adjustment value is at least the difference obtained by subtracting the occurrence time from the start time. Further, the time adjustment value is at least a sum of a preparation time and the difference obtained by subtracting the occurrence time from the start time. The preparation time is related to at least one of traffic or weather. When the start time is earlier than the occurrence time, the time adjustment value is related to a value relationship between the preparation time and a first time interval. The first time interval is a time interval between the start time and the occurrence time. When the preparation time is greater than the first time interval, the time adjustment value is at least a difference between the preparation time and the first time interval. When the preparation time is not greater than the first time interval, the time adjustment value is 0. For details, refer to the related part in the event embodiment. Details are not described herein again.

When the affecting factor is two factors: the weather and the traffic, the time adjustment value is determined based on the first message in the following two manners.

In a first manner, a time adjustment value corresponding to at least two external environment factors: the weather represented by the weather information included in the first message and the traffic represented by the traffic information may be determined according to the third mapping table. The third mapping table includes time adjustment values respectively corresponding to different combinations of the at least two external environment factors: the weather and the traffic. For details of the first implementation, refer to the embodiment in FIG. 27. Details are not described herein again.

In a second manner, the time adjustment value may be determined based on server data of a weather application and a traffic application. The server data of the weather application and the traffic application may include travel times in which different users travel in a target route in different weather and in different congestion length ranges. For details of the second implementation, refer to the embodiment in FIG. 28 to FIG. 31. Details are not described herein again.

Further, when the affecting factor is the weather, the traffic, and the event, the time adjustment value is determined based on the first message in the following two manners.

In a first manner, a time adjustment value corresponding to the weather represented by the weather information included in the first message, the traffic represented by the traffic information, and the event represented by the event information may be determined according to a fourth mapping table. The fourth mapping table may include time adjustment values corresponding to relationships between the start time of the alarm clock and different weather, different traffic congestion degrees, and different event occurrence times. For details of the first implementation, refer to the related part in the weather, traffic, and event embodiment Details are not described herein again.

In a second manner, the time adjustment value may be determined based on integrated server data of a weather application, a traffic application, and an event application. The integrated server data may include historical data of different users in relationships between the start time of the alarm clock and different weather, different traffic congestion degrees, and different event occurrence times. The event application includes an application that can provide a notification message including event information, for example, a short message service application, an email application, a calendar application, or a memo application. For details of the second implementation, refer to the related part in the weather, traffic, and event embodiment. Details are not described herein again.

S107. Adjust the start time based on the time adjustment value.

Specifically, after the time adjustment value is obtained, the start time of the alarm clock is adjusted forward by the time adjustment value. For example, when the time adjustment value is 20 minutes, and the start time of the alarm clock is 8:00, the start time of the alarm clock should be adjusted to 7:40. After the time adjustment value is obtained, when it is learned that an adjusted start time of the alarm clock is earlier than a current time, the alarm clock should immediately ring. For example, the current time is 7:35, the time adjustment value is 30 minutes, and the start time of the alarm clock is 8:00. In this case, the start time of the alarm clock should be originally adjusted to 7:30, which is earlier than the current time 7:35. Therefore, the alarm clock should immediately ring.

Specifically, when the user sets a plurality of alarm clocks, traffic represented by current traffic information obtained through analysis can affect an alarm clock only within a time period. Alternatively, an event represented by event information can affect an alarm clock only within a time period before or after an occurrence time of the event.

For example, it is assumed that the time period is two hours. In this case, a notification message of a traffic application is received at 8:00, and after a time adjustment value is obtained based on the notification message, a start time of only an alarm clock that does not ring before and at 10:00 can be adjusted.

Specifically, when time adjustment values obtained based on a plurality of first messages provided by a same application are inconsistent, a most original start time of the alarm clock should be adjusted based on a latest obtained time adjustment value. For example, the start time of the alarm clock is 8:00, namely, the original start time, but a time adjustment value 30 minutes is obtained based on a notification message received at 7:00. In this case, the start time of the alarm clock is adjusted to 7:30 based on the time adjustment value. When a time adjustment value 20 minutes is obtained based on a notification message received at 7:20, the original start time 8:00 of the alarm clock should be adjusted to 7:40 based on the current time adjustment value.

During implementation of this embodiment of the present invention, the start time of the alarm clock may be adjusted in real time based on different affecting factors represented by first messages provided by application programs to which the user subscribes in the first application list, ensuring that the user travels with punctuality.

In some embodiments of this application, an operating system of a mobile phone 100 is connected to a network of an operator by using an RF circuit 102, and is connected to a cloud server of a map vendor or a cloud server of a weather provider, to receive, in real time, a notification message pushed by the cloud server.

In some embodiments of this application, the Android system is used as an example. An example in which the alarm clock application parses content of a notification bar message of a subscribed application to adjust a preset alarm clock time in real time is used for description. The alarm clock application may use a NotificationListenerService (NotificatonListenerServer) capability provided by the Android system, to register, with the Android system, NotificationListenerService (NotificationListenerService) logic processing implemented in the alarm clock application, so that the content of the notification bar message of the subscribed application can be obtained.

The alarm clock application on the mobile phone 100 may perform lexical analysis on the content of the notification bar message by using a lexis parser, and identify, based on a keyword, real-time scenario information of a notification bar message pushed by an Amap application or a weather application. The lexis parser may be, for example, open source THULAC. The alarm clock application calculates a time adjustment value A based on road condition information pushed by the Amap application, and estimates an adjustment value C of a travel time based on information of the weather application. It is assumed that a current time is M, and an alarm time is N. If N is less than or equal to M+A+C, the alarm clock application may immediately trigger an alarm event. If N does not meet the condition, the mobile phone 100 may enter a sleep state until the alarm time of the alarm clock or arrival of a next pushed message.

In some embodiments of this application, the processor 101 may automatically calculate an alarm time of the alarm clock, receive, based on a list of subscribed applications stored in a memory 103 and by connecting to the Internet by using a Wi-Fi apparatus 107 or an RF circuit 102, notification messages of real-time data that are pushed by a map server and a weather server, perform semantic analysis on content of the notification messages, and evaluate an alarm clock adjustment value based on an obtained result. When the alarm time is adjusted, signaling is sent to an audio circuit 109 and a loudspeaker 113 to start an alarm operation in advance. When the processor 101 learns, through calculation, that the alarm clock needs to be triggered to ring, the audio circuit 109 and the loudspeaker 113 output a ring. Alternatively, the alarm clock application may be connected to a cloud map server or a cloud weather server by using the Wi-Fi apparatus 107, to receive, in real time, a notification message pushed by the server.

In some embodiments of this application, the mobile phone 100 pushes a message in a text form to a mobile phone application based on a scenario about which the user is concerned. An Amap application is used as an example. If the user is concerned about real-time road conditions of two places, the two places may be set in the Amap application. When monitoring a change in traffic road condition information, the Amap server sends a notification message to the mobile phone 100. Specifically, the processor 101 in the mobile phone 100 receives the notification message by using the Wi-Fi apparatus 107 or the radio frequency circuit 102, instructs a corresponding application to submit content of the notification message to a notification service of the operating system, and displays notification bar information of the mobile phone 100 by using a display 104-2. The notification service of the Android system applies the content of the notification message to the alarm clock application by using the processor 101. The Android system is used as an example. The alarm clock application registers message subscription logical processing with the operating system. When an application message is pushed to the mobile phone, the Android operating system submits text content of the message and an associated application identifier (packageName) to the NotificationListenerService logical processing previously registered by the alarm clock application. Text information pushed in a notification bar may be obtained by using an Android system function StatusBarNotiflcation.getCharSequence(Notification.EXTRA_TEXT), and an identifier of an application from which the message comes may be obtained by using an Android system function StatusBarNotiflcation.getPackageName( ). The alarm clock application then reads, by using sqlite, a list of identifiers of applications to which the user subscribes. If the identifier of the application for the message is within the list of identifiers of subscribed applications, processing is performed. Otherwise, the notification bar message is not processed. The processor 101 in the mobile phone 100 receives content of the notification message, and compares the identifier of the source application corresponding to the notification message with the list of subscribed applications previously stored in the memory 103. If the identifier is within the subscription list, processing is performed. Otherwise, no processing is performed. The processor 101 analyzes the text content based on the lexis parser, extracts a keyword, and identifies a time adjustment value. A text of the notification message pushed by the Amap server is used as an example to describe analysis of the lexis parser. For example, the notification message pushed by the Amap server is “there is a traffic jam of 30 minutes from an A center bookstore to a B stadium”. A result obtained through analysis by the processor 101 by using the lexis parser is A_ns center_a bookstore_n to_v B_nz stadium_ni traffic jam_v 30_m minutes_q, where ns indicates a place name, a indicates an adjective, n indicates a noun, v indicates a verb, nz indicates another proper noun, ni indicates an institution name, v indicates a verb, m indicates a numeral, and q indicates a quantifier. The processor 101 may learn, through parsing and by extracting the place name, the institution name, the verb, the numeral, and the quantifier, that the time adjustment value is 30 minutes because of the traffic jam. The processor 101 performs calculation based on the preset alarm clock time, the current time, and the time adjustment value that are stored in the memory 103; and triggers an alarm operation if a condition is met.

In this embodiment of this application, an application subscription mode is added to the alarm clock application to provide the user with a list of applications that can be subscribed to, so that the user can subscribe to a notification message in a notification bar of an application such as a calendar application, a short message service application, an email application, a weather application, or a map application, and a terminal can listen to a notification message of a subscribed application in real time to adjust a preset alarm clock time. Therefore, an alarm clock is adjusted in real time, and the alarm clock is more accurately and flexibly adjusted. By listening to the notification message of the subscribed application, the terminal can more precisely and intelligently manage the alarm time of the alarm clock, to prevent the user from being late because of a weather or road condition emergency. When the user sets an alarm clock, external scenario information such as a road condition and weather may be collected in real time by subscribing to notification bar messages of various applications, and an alarm time is automatically adjusted, thereby greatly improving user travel convenience.

In some embodiments of this application, content of a notification message in a notification bar may alternatively be obtained by using the NotificationListenerService (NotificationListenerService), a time adjustment value is obtained based on an external scenario factor that is obtained based on the lexis parser, and further a preset alarm time is adjusted based on the time adjustment value. Therefore, alarm accuracy is improved, and automatic adjustment efficiency and intelligence of a terminal are improved.

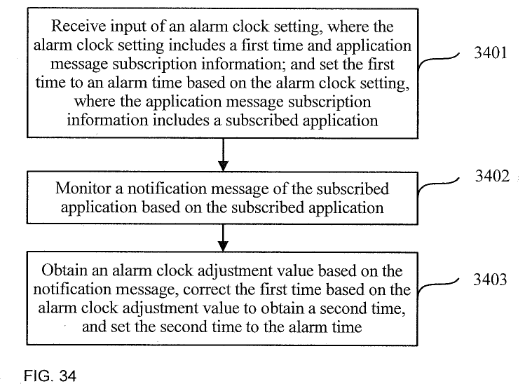

As shown in FIG. 34, an embodiment of this application provides an alarm clock reminder method. The method is implemented on an electronic device. The method includes the following steps:

S3401. The electronic device receives input of an alarm clock setting, where the alarm clock setting includes a first time and application message subscription information; and sets the first time to an alarm time based on the alarm clock setting, where the application message subscription information includes a subscribed application.

S3402. The electronic device monitors a notification message of the subscribed application based on the subscribed application.

S3403. The electronic device obtains an alarm clock adjustment value based on the notification message, corrects the first time based on the alarm clock adjustment value to obtain a second time, and sets the second time to the alarm time.

In this embodiment, the electronic device more flexibly sets and adjusts an alarm clock, and makes a prompt with an alarm in a timely manner, thereby improving intelligence of the electronic device and user experience.

In some embodiments of this application, the notification message includes a notification message in a notification bar of the electronic device.

In some embodiments of this application, the subscribed application includes at least two applications. For example, because weather and traffic have relatively great impact on travel of a user, the subscribed application may include a weather application and a map application. A temporary meeting notification also affects travel of the user, the subscribed application may further include a calendar application or an email application.

In some embodiments of this application, that the electronic device obtains an alarm clock adjustment value based on the notification message specifically includes: The electronic device obtains event information in the notification message, determines whether an occurrence time of an event represented by the event information in the notification message falls within a time range associated with a start time of an alarm clock, and obtains the alarm clock adjustment value based on the event information if the occurrence time of the event is earlier than the start time and if a difference obtained by subtracting the occurrence time of the event from the start time is less than a first threshold.

In some embodiments of this application, that the electronic device obtains an alarm clock adjustment value based on the notification message specifically includes: The electronic device obtains event information in the notification message, determines whether an occurrence time of an event represented by the event information in the notification message falls within a time range associated with a start time of an alarm clock, and obtains the alarm clock adjustment value based on the event information if the start time is earlier than the occurrence time of the event and if a difference obtained by subtracting the start time from the occurrence time of the event is less than a second threshold.

In some embodiments of this application, the alarm clock setting includes a target route, the notification message includes a travel time required in the target route in a first weather condition, and that the electronic device obtains an alarm clock adjustment value based on the notification message specifically includes: The electronic device determines the alarm clock adjustment value based on the travel time required in the first weather information condition. The travel time required in the target route in the first weather condition may be obtained by using a weather application, may be obtained by using a map application, or may be obtained jointly by using two applications. This is not specifically limited in this embodiment of this application.

In some embodiments of this application, the subscribed application includes a calendar application, and the obtaining an alarm clock adjustment value based on the notification message further specifically includes: determining the alarm clock adjustment value based on event information in notification information of the calendar application.

In some embodiments of this application, the electronic device analyzes the notification message by using a lexis parser.

In some embodiments of this application, the electronic device receives an operation of querying the alarm clock, and displays information about a subscribed application of the alarm clock.

In some embodiments of this application, that the electronic device obtains an alarm clock adjustment value based on the notification message further specifically includes: The electronic device obtains, by querying a mapping table based on the event information in the notification message, the alarm clock adjustment value corresponding to the event information.

As shown in FIG. 33, an embodiment of this application discloses a terminal device 3310. The terminal device 3310 may include a touchscreen 3311, a processor 3312, and a memory 3313, and further includes one or more communications buses 3314 connected to the foregoing components. The terminal device 3310 in this embodiment of this application may be configured to perform the methods in the foregoing embodiments and the technical solutions in the accompanying drawings.

An embodiment of this application further provides a terminal device. The terminal device has a function of implementing terminal device behavior in the foregoing method designs. The function may be implemented by hardware, or may be implemented by hardware by executing corresponding software. The hardware or the software includes one or more modules corresponding to the function.

All or some of the foregoing embodiments may be implemented by using software, hardware, firmware, or any combination thereof. When software is used to implement the embodiments, the embodiments may be implemented completely or partially in a form of a computer program product. The computer program product includes one or more computer instructions. When the computer program instructions are loaded and executed on the computer, the procedures or functions according to the embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid state disk), or the like.

For a purpose of explanation, the foregoing descriptions are provided with reference to the specific embodiments. However, the foregoing example discussion is not intended to be detailed, and is not intended to limit this application to a disclosed precise form. Based on the foregoing teaching content, many modification forms and variation forms are possible. The embodiments are selected and described to fully illustrate the principles of this application and practical application of the principles, so that other persons skilled in the art can make full use of this application and various embodiments that have various modifications applicable to conceived specific usage.

1-18. (canceled)

19. An alarm clock reminder method, wherein the method is implemented on an electronic device, and the method comprises:
displaying a first interface for creating an alarm clock of an alarm clock app; wherein the first interface comprises a first area displaying a first time set to an alarm time of the alarm clock and a second area displaying an application subscription control;
displaying a second interface when receiving a first operation on the application subscription control, wherein the second interface comprises a mode on/off control and an application list, the mode on/off control is configured to receive a second operation that is of enabling or disabling a subscription mode, a third operation entered by the user on the application list is valid when the subscription mode is enabled, the third operation entered by the user on the application list is invalid when the subscription mode is disabled, the application list presents a plurality of applications;
receiving the second operation to enable the subscription mode;
receiving the third operation on the application list to choose a subscribed application;
monitoring a notification message of the subscribed application; and
obtaining an alarm clock adjustment value based on the notification message, correcting the first time based on the alarm clock adjustment value to obtain a second time, and setting the second time to the alarm time.

20. The method according to claim 19, wherein the notification message is present in a notification bar of the electronic device.

21. The method according to claim 19, wherein the subscribed application comprises one or more applications in the application list.

22. The method according to claim 19, wherein the obtaining the alarm clock adjustment value based on the notification message specifically comprises: obtaining event information in the notification message, determining whether an occurrence time of an event represented by the event information in the notification message falls within a time range associated with the first time of the alarm clock, and obtaining the alarm clock adjustment value based on the event information if the occurrence time of the event is earlier than the first time and if a difference obtained by subtracting the occurrence time of the event from the first is less than a first threshold.

23. The method according to claim 19, wherein the obtaining the alarm clock adjustment value based on the notification message specifically comprises: obtaining event information in the notification message, determining whether an occurrence time of an event represented by the event information in the notification message falls within a time range associated with the first time of the alarm clock, and obtaining the alarm clock adjustment value based on the event information if the first time is earlier than the occurrence time of the event and if a difference obtained by subtracting the first time from the occurrence time of the event is less than a second threshold.

24. The method according to claim 19, wherein the first interface comprises a third area displaying a target route, the notification message comprises a travel time required in the target route in a first weather condition, and the obtaining the alarm clock adjustment value based on the notification message comprises: determining the alarm clock adjustment value based on the travel time required in the first weather condition.

25. The method according to claim 19, wherein the subscribed application comprises a calendar application, and the obtaining the alarm clock adjustment value based on the notification message further specifically comprises: determining the alarm clock adjustment value based on event information in notification information of the calendar application.

26. The method according to claim 19, wherein the method further comprises: analyzing, by the electronic device, the notification message by using a lexis parser.

27. The method according to claim 19, wherein the method further comprises: receiving an operation of querying the alarm clock, and displaying information about the subscribed application of the alarm clock.

28. The method according to claim 22, wherein the obtaining the alarm clock adjustment value based on the notification message further specifically comprises: obtaining, by querying a mapping table based on the event information in the notification message, the alarm clock adjustment value corresponding to the event information.

29. An electronic device, wherein the electronic device comprises a touch screen, a memory, one or more processors, and one or more programs, the one or more programs are stored in the memory, and when the one or more processors execute the one or more programs, the terminal device performs the method comprising:
displaying a first interface for creating an alarm clock of an alarm clock app; wherein the first interface comprises a first area displaying a first time set to an alarm time of the alarm clock and a second area displaying an application subscription control;
displaying a second interface when receiving a first operation on the application subscription control, wherein the second interface comprises a mode on/off control and an application list, the mode on/off control is configured to receive a second operation that is of enabling or disabling a subscription mode, a third operation entered by the user on the application list is valid when the subscription mode is enabled, the third operation entered by the user on the application list is invalid when the subscription mode is disabled, the application list presents a plurality of applications;
receiving the second operation to enable the subscription mode;
receiving the third operation on the application list to choose a subscribed application;
monitoring a notification message of the subscribed application; and
obtaining an alarm clock adjustment value based on the notification message, correcting the first time based on the alarm clock adjustment value to obtain a second time, and setting the second time to the alarm time.

30. The electronic device according to claim 29, wherein the notification message is present in a notification bar of the electronic device.

31. The electronic device according to claim 29, wherein the obtaining the alarm clock adjustment value based on the notification message specifically comprises: obtaining event information in the notification message, determining whether an occurrence time of an event represented by the event information in the notification message falls within a time range associated with the first time of the alarm clock, and obtaining the alarm clock adjustment value based on the event information if the occurrence time of the event is earlier than the first time and if a difference obtained by subtracting the occurrence time of the event from the first is less than a first threshold.

32. The electronic device according to claim 29, wherein the obtaining an alarm clock adjustment value based on the notification message specifically comprises: obtaining event information in the notification message, determining whether an occurrence time of an event represented by the event information in the notification message falls within a time range associated with the first time of an alarm clock, and obtaining the alarm clock adjustment value based on the event information if the first time is earlier than the occurrence time of the event and if a difference obtained by subtracting the first time from the occurrence time of the event is less than a second threshold.

33. The electronic device according to claim 29, wherein the first interface comprises a third area displaying a target route, the notification message comprises a travel time required in the target route in a first weather condition, and the obtaining an alarm clock adjustment value based on the notification message specifically comprises: determining the alarm clock adjustment value based on the travel time required in the first weather condition.

34. The electronic device according to claim 29, wherein the subscribed application comprises a calendar application, and the obtaining the alarm clock adjustment value based on the notification message further comprises: determining the alarm clock adjustment value based on event information in notification information of the calendar application.

35. The electronic device according to claim 29, wherein the method further comprises: analyzing, by the electronic device, the notification message by using a lexis parser.

36. The electronic device according to claim 29, wherein the method further comprises: receiving an operation of querying the alarm clock, and displaying information about the subscribed application of the alarm clock.

37. The electronic device according to claim 31, wherein the obtaining the alarm clock adjustment value based on the notification message further specifically comprises: obtaining, by querying a mapping table based on the event information in the notification message, the alarm clock adjustment value corresponding to the event information.

38. A computer readable storage medium, comprising an instruction, wherein when the computer readable storage medium runs on a computer, the computer performs the method comprising:
displaying a first interface for creating an alarm clock of an alarm clock app; wherein the first interface comprises a first area displaying a first time set to an alarm time of the alarm clock and a second area displaying an application subscription control;
displaying a second interface when receiving a first operation on the application subscription control, wherein the second interface comprises a mode on/off control and an application list, the mode on/off control is configured to receive a second operation that is of enabling or disabling a subscription mode, a third operation entered by the user on the application list is valid when the subscription mode is enabled, the third operation entered by the user on the application list is invalid when the subscription mode is disabled, the application list present a plurality of applications;
receiving the second operation to enable the subscription mode;
receiving the third operation on the application list to choose a subscribed application;
monitoring a notification message of the subscribed application; and
obtaining an alarm clock adjustment value based on the notification message, correcting the first time based on the alarm clock adjustment value to obtain a second time, and setting the second time to the alarm time.
